(19) United States
(12) Patent Application Publication
(10) Pub. No.: US 2003/0050883 A1
(43) Pub. Date: Mar. 13, 2003

(54) Method and device for providing asset information

(76) Inventors: Jonathan D. Weir, Buffalo, NY (US); William M. Weir, Orchard Park, NY (US); Raymond J. Fagullar, Lancaster, NY (US); Kathleen M. Nicotera, Eden, NY (US)

Correspondence Address: George L. Snyder, Jr., Hodgson Russ LLP, Suite 2000, One M&T Plaza, Buffalo, NY, 14203-2391, US

(21) Appl. No.: 10/197,097

(22) Filed: Jul. 17, 2002

Related U.S. Application Data
(60) Provisional application No. 60/306,025, filed on Jul. 17, 2001.

(51) Int. Cl. G06F 17/60

(52) U.S. Cl. 705/35

(57) ABSTRACT

A computer program product, a computer system, and a computer-implemented method are based on spreadsheet software that provides a plurality of user interface sheets including a summary sheet for calculating and indicating spendable income and total estate value for a plurality of different years in a planned range of years; a data input sheet for receiving participant plan information including a participant name, a start age, a retire age, a death age, a consumer price index rate, and a start year; a tax table sheet for receiving currently applicable tax rate information; and a plurality of categorized sheets for receiving and calculating information from which the spendable income and total estate value are calculated. Each user interface sheet is selectable by a user by entering a single input command, for example by clicking a mouse, for fast navigation.

### CROSS-REFERENCES TO RELATED APPLICATIONS

The present application claims benefit under 35 U.S.C. 119(e) of U.S. Provisional Patent Application Serial No. 60/306,025 filed Jul. 17, 2001.

### BACKGROUND OF THE INVENTION

The present invention relates generally to the field of financial planning, and more particularly to computer program products, computer systems, and computer-implemented methods for providing one or more participants with information regarding spendable income and estate value over a planned range of years.

Currently available software for financial retirement planning generally suffers from several drawbacks. First, the software is often structured in separate modules corresponding to different financial source categories, and the modules are not integrated for easy navigation. Second, currently available software often does not allow the user to easily see the net present value of amounts based on a consumer price index rate. Third, currently available software frequently lacks capability for handling information with respect to financial sources or vehicles that are less widely used by individuals.

### BRIEF SUMMARY OF THE INVENTION

It is therefore an object of the present invention to provide a computer program product, a computer system, and a computer-implemented method for providing asset information, including hypothetical asset information, regarding a single participant or a couple for purposes of retirement planning over a planned range of years or timeline.

It is another object of the present invention to provide a computer program product, a computer system, and a computer-implemented method capable of providing the above-mentioned asset information in terms of today's dollars.

It is a further object of the present invention to provide a computer program product, a computer system, and a computer-implemented method capable of projecting value and income characteristics of a variety of categorized financial vehicles and integrating the projections into a summary form, whereby the overall impact of changes with respect to one or more of the financial vehicles can be readily reported and understood.

In furtherance of these and other objects, the present invention is embodied in a computer program product comprising a computer-readable medium having stored thereon a program code executable to provide a plurality of user interface sheets preferably including at least one summary sheet for calculating and indicating spendable income and total estate value for a plurality of different years in a planned range of years; a data input sheet for receiving participant plan information including a participant name, a start age, a retire age, a death age, a consumer price index rate, and a start year; a tax table sheet for receiving currently applicable tax rate information; a plurality of categorized sheets for receiving and calculating information from which the spendable income and total estate value are calculated; an assumption sheet for indicating assumed parameters and inputted information; and a consumer price index adjustment sheet for use in converting future projected monetary values into equivalent present monetary values. In a present embodiment, the categorized sheets include a Social Security sheet, a savings sheet, a deferred income sheet, a salary and other income sheet, a qualified plan sheet, a real estate sheet, an other income and property sheet, an equities sheet, an equity sale sheet, a business stocks sheet, a business stock sale sheet, a tax free investments sheet, a bond based insurance trust sheet, a miscellaneous debt sheet, a miscellaneous debt outlay sheet, a non-irrevocable life insurance trust sheet, and a credit shelter trust sheet. In accordance with the present invention, each user interface sheet includes a graphical icon that a user can click to display the corresponding sheet. As will be appreciated, the program format integrates information from a variety of financial sources or vehicles and allows the user to quickly and easily adjust assumptions and see the consequences of adjustments to assist in developing a retirement plan.

The present invention is also embodied in a computer system comprising hardware and software, and a computer-implemented method.

### BRIEF DESCRIPTION OF THE SEVERAL VIEWS OF THE DRAWING

The nature and mode of operation of the present invention will now be more fully described in the following detailed description of the invention taken with the accompanying drawing figures, in which:

FIG. 1 is a schematic diagram of a computer system formed in accordance with a first embodiment of the present invention;

FIG. 2 is a schematic diagram of a computer system formed in accordance with a second embodiment of the present invention;

FIG. 3 is a composite of multiple screen captures (FIGS. 3A-3I) showing a Totals Summary sheet provided by a computer software program of the present invention;

FIG. 4 is a composite of multiple screen captures (FIGS. 4A-4C) showing a Summary 1-5-10-20 sheet provided by the computer software program;

FIG. 5 is a composite of multiple screen captures (FIGS. 5A-5B) showing a 30-year Summary sheet provided by the computer software program;

FIG. 6 is a composite of multiple screen captures (FIGS. 6A-6B) showing a 20-year Summary sheet provided by the computer software program;

FIG. 7 is a screen capture showing an Assumption sheet provided by the computer software program;

FIG. 8 is a screen capture showing a Data Input sheet provided by the computer software program;

FIG. 9 is a composite of multiple screen captures (FIGS. 9A-9D) showing a Tax Table sheet provided by the computer software program;

FIG. 10 is a composite of multiple screen captures (FIGS. 10A-10B) showing a Social Security sheet provided by the computer software program;

FIG. 11 is a composite of multiple screen captures (FIGS. 11A-11D) showing a Savings sheet provided by the computer software program;

FIG. 12 is a composite of multiple screen captures (FIGS. 12A-12D) showing a Deferred Income sheet provided by the computer software program;

FIG. 13 is a composite of multiple screen captures (FIGS. 13A-13B) showing a Salary and Other Income sheet provided by the computer software program;

FIG. 14 is a composite of multiple screen captures (FIGS. 14A-14D) showing a Qualified Plan sheet provided by the computer software program;

FIG. 15 is a composite of multiple screen captures (FIGS. 15A-15B) showing a Real Estate sheet provided by the computer software program;

FIG. 16 is a screen capture showing an Other2 sheet provided by the computer software program;

FIG. 17 is a composite of multiple screen captures (FIGS. 17A-17D) showing an Equities sheet provided by the computer software program;

FIG. 18 is a composite of multiple screen captures (FIGS. 18A-18B) showing an Equity Sale sheet provided by the computer software program;

FIG. 19 is a screen capture showing a Business Stocks sheet provided by the computer software program;

FIG. 20 is a composite of multiple screen captures (FIGS. 20A-20B) showing a Business Stock Sale sheet provided by the computer software program;

FIG. 21 is a composite of multiple screen captures (FIGS. 21A-21D) showing a Tax Free Investments sheet provided by the computer software program;

FIG. 22 is a composite of multiple screen captures (FIGS. 22A-22D) showing an Other sheet provided by the computer software program;

FIG. 23 is a composite of multiple screen captures (FIGS. 23A-23B) showing an Other1 sheet provided by the computer software program;

FIG. 24 is a composite of multiple screen captures (FIGS. 24A-24D) showing a BBIT sheet provided by the computer software program;

FIG. 25 is a composite of multiple screen captures (FIGS. 25A-25B) showing a Miscellaneous Debt sheet provided by the computer software program;

FIG. 26 is a composite of multiple screen captures (FIGS. 26A-26B) showing a Miscellaneous Debt Outlay sheet provided by the computer software program;

FIG. 27 is a composite of multiple screen captures (FIGS. 27A-27D) showing a Group Term Life Insurance sheet provided by the computer software program;

FIG. 28 is a composite of multiple screen captures (FIGS. 28A-28D) showing a Credit Shelter Trust sheet provided by the computer software program; and

FIG. 29 is a composite of multiple screen captures (FIGS. 29A-29D) showing a Consumer Price Index Adjustment sheet provided by the computer software program.

### DETAILED DESCRIPTION OF THE INVENTION

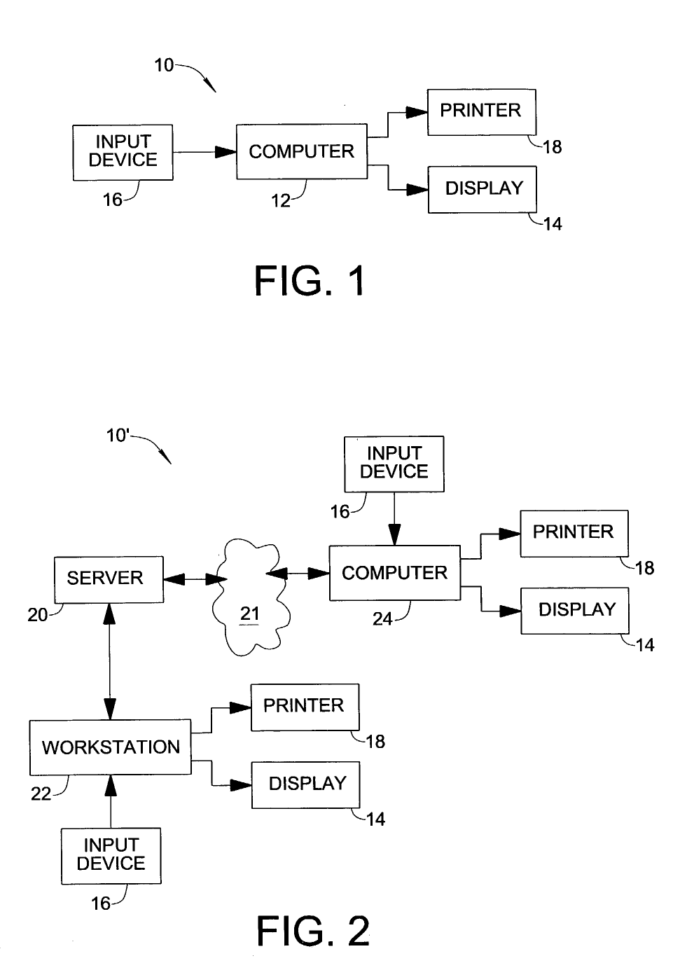

Referring initially to FIG. 1 of the drawings, a computer system formed in accordance with a first embodiment of the present invention is shown schematically and designated generally by the reference numeral 10. Computer system 10 preferably comprises a standard personal computer 12, a display monitor 14 connected to computer 12, an input device 16 such as a mouse, keyboard, trackball, or the like, and a printer 18.

FIG. 2 shows a computer system 10′ formed in accordance with a second embodiment of the present invention. Computer system 10′ comprises a server 20 connected to a global information network 21 (the internet) and a computer workstation 22 connected to the server. For purposes of descriptive illustration, workstation 22 is used by a qualified financial planner. Computer system 10′ further comprises a participant computer 24 connected to the internet and thereby linked to server 20. For purposes of descriptive illustration, participant computer 24 is used by an individual or individuals (“participants”) seeking financial planning services. A display 14, input device 16, and printer 18 are connected to workstation 20 and to participant computer 24.

Computer systems 10 and 10′ are characterized in that each is operable to execute a computer program according to the present invention to provide asset information regarding at least one participant for purposes of retirement planning. The computer program is preferably stored on a hard disk drive of computer 12 or server 20, as the case may be. However, it will be understood that the computer program can be contained on any computer-readable medium. As used herein, a “computer-readable medium” is any article of manufacture that contains data that can be read by a computer or a carrier wave signal carrying data that can be read by a computer. For example, the software program of the present invention may be distributed on magnetic, such as a floppy disk, flexible disk, hard disk, reel-to-reel tape, cartridge tape and cassette tape; optical media, such as a CD-ROM and writable compact disk; and paper media, such as punched cards and paper tape; or on a carrier wave signal received through a network, wireless network, or modem, including radio-frequency signals and infrared signals.

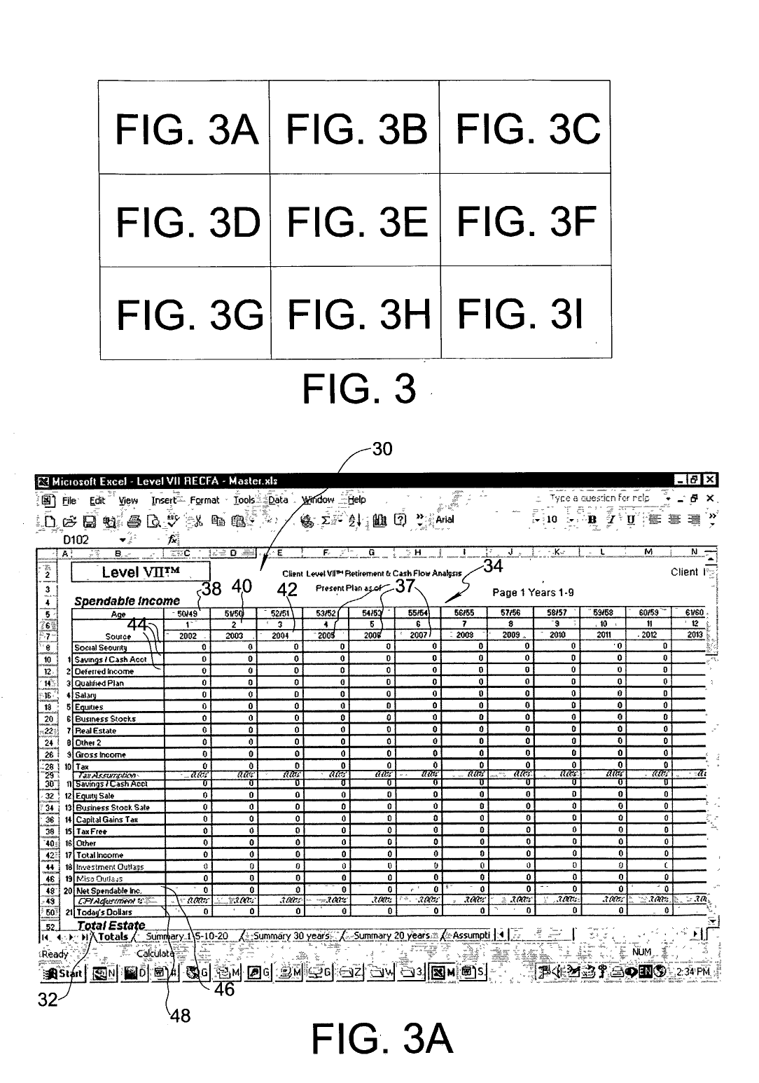

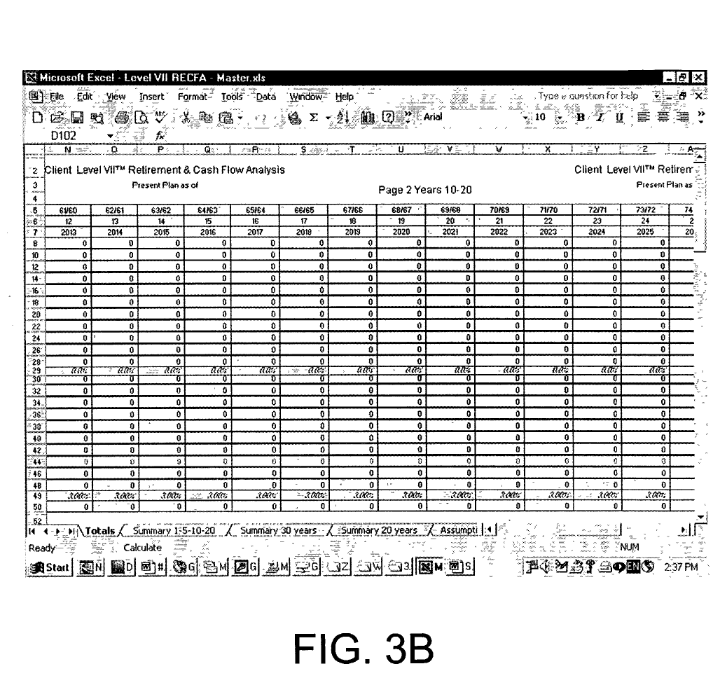

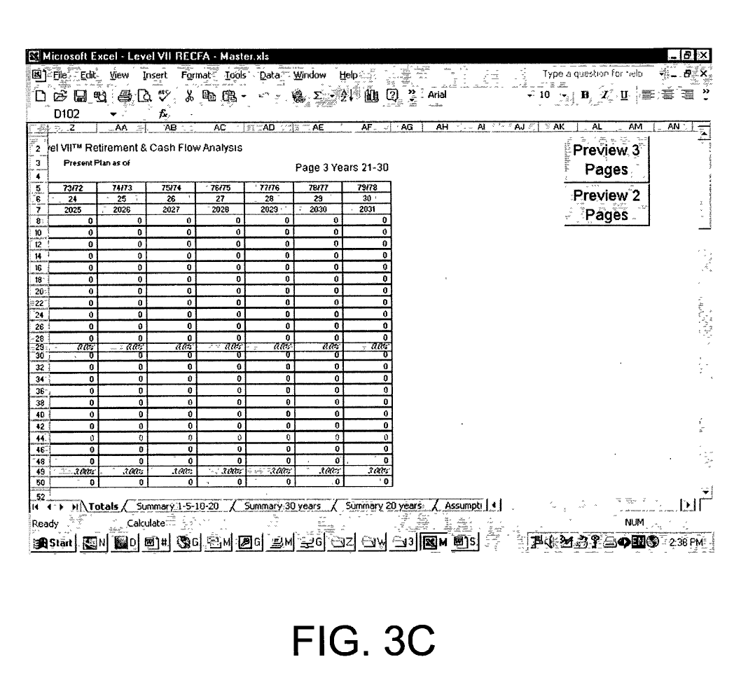

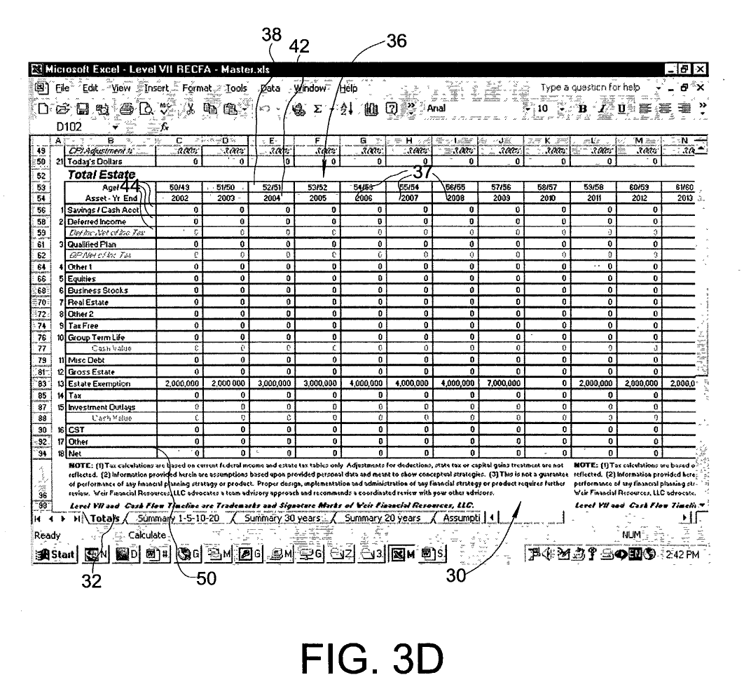

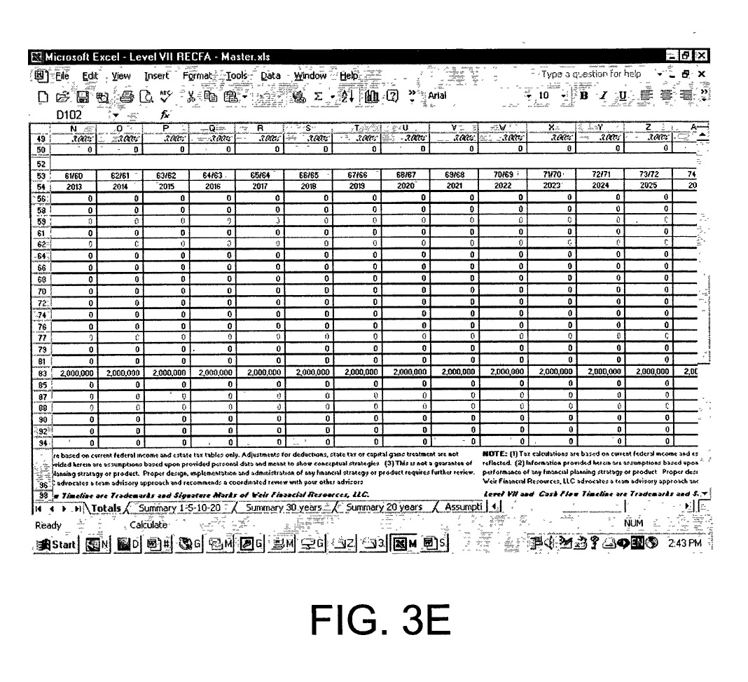

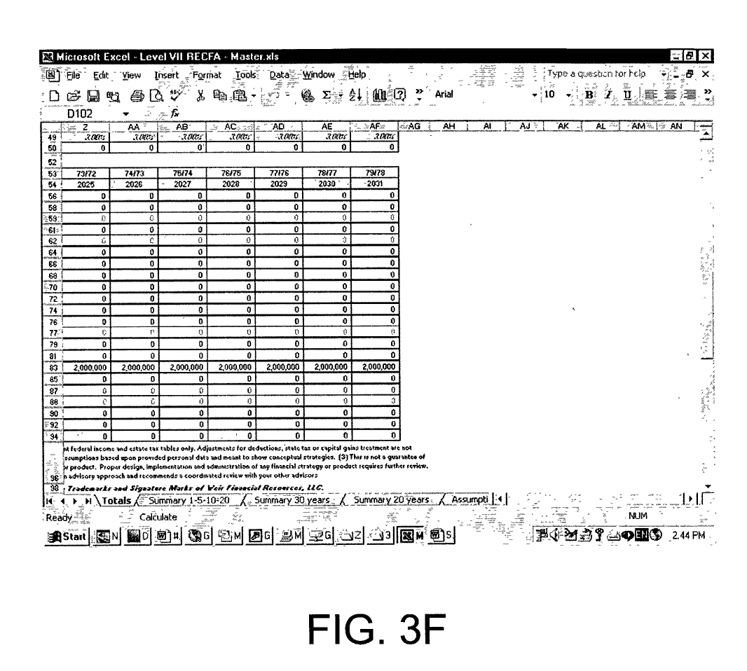

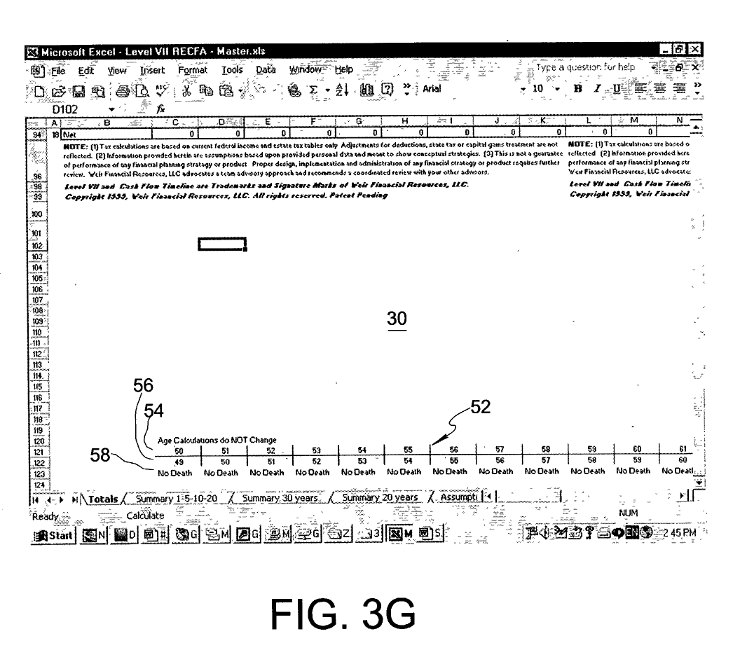

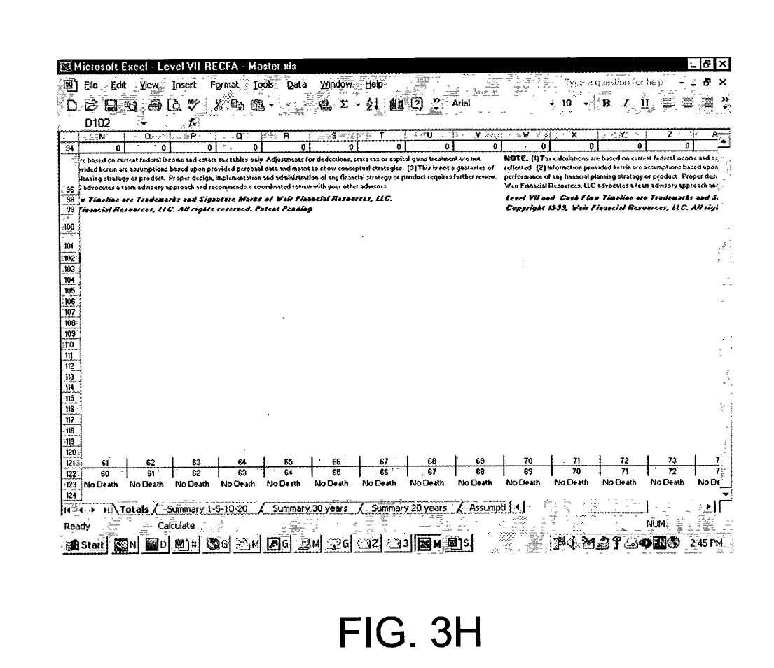

The computer program implemented in accordance with the present invention is designed to assist a financial planner in providing asset information to a participant or a pair of participants to quickly and easily show the effects of future financial decisions and circumstances on participant spendable income and estate value over a planned timeline or range of years. The computer program of the present invention is preferably embodied as a MICROSOFT® Excel™ file on a computer-readable medium, however other spreadsheet programming software may be used to practice the present invention. During execution, the computer program provides a plurality of user interface sheets visible on display 14. From a broad standpoint, the program provides at least one summary sheet for calculating and indicating spendable income and total estate value for a plurality of different years in the planned range of years; a data input sheet for receiving participant plan information including a participant name, a start age, a retire age, a death age, a consumer price index rate, and a start year; a tax table sheet for receiving currently applicable tax rate information; and a plurality of categorized sheets for receiving and calculating information used the summary sheet(s) to calculate spendable income and said total estate value. In the preferred embodiment software program described herein, each user interface sheet has associated therewith a graphical icon, preferably a tab icon, which the user can “click” to display the corresponding user interface sheet. The terms “click” and “clicking” as used herein refer broadly to entry of an input command to a computer, whether or not such command is entered by single clicking or double clicking a mouse, entering a keyboard stroke comprising one or more keys; touching a display screen or touch pad, or otherwise entering an input command. The particular user interface sheets of the preferred embodiment will now be described in detail with reference to FIGS. 3 through 28, many of which are composite figures made up of several screen capture images in order to show the complete user interface sheet of interest.

Totals Sheet. A Totals sheet 30 of the present invention is shown in FIG. 3 and generally includes a graphical icon tab 32, a Spendable Income table 34, a Total Estate table 36, and an Age table 52.

Spendable Income table 34 (object name “apilook”) is a two-dimensional table having a plurality of columns 37 and rows 44. Each column 37 corresponds to a different year in a planned timeline range of thirty years. At the top of each column is a box 38 indicating each participant's age, a box 40 indicating the corresponding year of the plan, and a box 42 indicating the actual corresponding calendar year. The respective age values in box 38 are derived from Age table 52 described below. Rows 44 correspond to other user interface sheets containing table objects which are the source of data in the particular row, or to calculations or parameters related to spendable income. The following table (Table 1) provides Excel function information for each row cell in the “C” column (plan year 1) of the Spendable Income table, beginning with the top row labeled “Social Security” and working downward as seen in FIG. 3A to the row labeled “Today's Dollars”. Excel objects referenced in the listed functions will be identified parenthetically herein in relation to a corresponding user interface sheet or table containing the object.

TABLE 1

| ROW LABEL | FUNCTION |
|---|---|
| Social Security | =IF(C123=“Dead”,“”,VLOOKUP(C$6,sstable,6)) |
| Savings / Cash | =IF(C123=“Dead”,“”,VLOOKUP(C$6,savings_table,4)) |
| Acct | |
| Deferred Income | =IF(C123=“Dead”,“”,VLOOKUP(C$6,definc_table,3)) |
| Qualified Plan | =IF(C123=“Dead”,“”,VLOOKUP(C$6,qp_table,3)) |
| Salary | =IF(C123=“Dead”,“”,VLOOKUP(C$6,otherincome,5)) |
| Equities | =IF(C123=“Dead”,“”,VLOOKUP(C$6,stocks_table,3)+VLOO |
| | KUP(C6,EQUITIES,13)) |
| Business Stocks | =IF(C123=“Dead”,“”,VLOOKUP(C$6,cstocks_table,3)) |
| Real Estate | =IF(C123=“Dead”,“”,VLOOKUP(C$6,rents_table,5)) |
| Other 2 | =IF(C123=“Dead”,“”,VLOOKUP(C$6,otherrents,5)) |
| Gross Income | =IF(C123=“Dead”,“”,SUM(C8:C24)) |
| Tax | =IF(C123=“Dead”,“”,IF(couplesingle=“single”,+(VLOOKUP(C |
| | 26,singleit,2)+IF((C26−VLOOKUP(C26,singleit,1))>0,((C26− |
| | VLOOKUP(C26,singleit,1))*VLOOKUP(C26,singleit,3))))*− |
| | 1,IF(C121>0,+(VLOOKUP(C26,inctax,2)+IF((C26− |
| | VLOOKUP(C26,inctax,1))>0,((C26− |
| | VLOOKUP(C26,inctax,1))*VLOOKUP(C26,inctax,3))))*− |
| | 1,+(VLOOKUP(C26,singleit,2)+IF((C26− |
| | VLOOKUP(C26,singleit,1))>0,((C26− |
| | VLOOKUP(C26,singleit,1))*VLOOKUP(C26,singleit,3))))*− |
| | 1))) |
| Tax Assumption | =IF(C123=“Dead”,“”,IF(C26=0,0,+C28/C26)) |
| Savings / Cash | =IF(C123=“Dead”,“”,VLOOKUP(C$6,savings_table,3)) |
| Acct | |
| Equity Sale | =IF(C123=“Dead”,“”,VLOOKUP(C$6,stocksale_table,7)) |
| Business Stock | =IF(C123=“Dead”,“”,VLOOKUP(C$6,cstocksale_table,7)) |
| Sale | |
| Capital Gains Tax | =IF(C123=“Dead”,“”,VLOOKUP(C$6,stocksale_table,6)+VLO |
| | OKUP(C$6,cstocksale_table,6)) |
| Tax Free | =IF(C123=“Dead”,“”,VLOOKUP(C$6,TF_table,12)) |
| Other | =IF(C123=“Dead”,“”,VLOOKUP(C$6,Deferred_tableta,12)) |
| Total Income | =IF(C123=“Dead”,“”,+C26+C28+C32− |
| | C36+C38+C34+C40+C30) |
| Investment Outlays | =IF(C123=“Dead”,“”,−VLOOKUP(C6,Ilit_table,2)− |
| | VLOOKUP(C$6,savings_table,4)− |
| | VLOOKUP(C$6,savings_table,5)− |
| | VLOOKUP(C$6,EQUITIES,13)+VLOOKUP(C$6,EQUITIE |
| | S,7)−VLOOKUP(C$6,definc_table,7)− |
| | VLOOKUP(C$6,attable1,9)−VLOOKUP(C$6,attable2,6)− |
| | VLOOKUP(C$6,in_table,6)− |
| | VLOOKUP(C$6,cstocks_table,8)− |
| | VLOOKUP(C$6,Realestate_table,5)− |
| | VLOOKUP(C$6,stocks_table,10)− |
| | VLOOKUP(C$6,savings_table,8)− |
| | VLOOKUP(C$6,TF_table,6)− |
| | VLOOKUP(C$6,Deferred_tableta,7)− |
| | VLOOKUP(C$6,qp_table,7)) |
| Misc Outlays | =IF(C123=“Dead”,“”,VLOOKUP(C$6,debttable,3)*− |
| | 1+(VLOOKUP(C$6,otherrevals,6)*− |
| | 1)+IF(RealEstate!$U$5=“Yes”,(VLOOKUP(C$6,Loantable,3) |
| | *−1)+(VLOOKUP(C$6,Loantable,9)*− |
| | 1),0))+(VLOOKUP(C$6,Debtpayable,2)*−1) |
| Net Spendable Inc. | =IF(C123=“Dead”,“”,+C42+C46+C44) |
| CPI Adjustment % | 0.0% for “C” column (Plan Year 1) and applicable CPI rate |
| | for all subsequent columns |
| Today's Dollars | =IF(C123=“Dead”,“”,HLOOKUP(C6,cpiadjtable,2)) |

As will be appreciated, Spendable Income table 34 of Totals sheet 30 includes a row 46 containing a value of net spendable income for each year in the planned range of years, and a row 48 containing a value of net spendable income in today's dollars.

Total Estate table 36 is a two-dimensional table similar in organization to Spendable Income table 34 and having a plurality of columns 37 and rows 44. Each column 37 corresponds to a different year in a planned timeline range of thirty years. At the top of each column is a box 38 indicating each participant's age, and a box 42 indicating the actual corresponding calendar year. Rows 44 correspond to other user interface sheets containing table objects which are the source of data in the particular row, or to calculations or parameters related to year end total estate value. The following table (Table 2) provides Excel function information for each row cell in the “C” column (plan year 1) of Total Estate table 36, beginning with the top row labeled “Savings/Cash Acct” and working downward as seen in FIG. 3D to the row labeled “Net”. Excel objects referenced in the listed functions will be identified parenthetically herein in relation to a corresponding user interface sheet containing the object.

TABLE 2

| ASSET-YR. END | FUNCTION |
|---|---|
| Savings / Cash Acct | =IF(C123=“Dead”,“”,VLOOKUP(C$6,savings_table,6)) |
| Deferred Income | =IF(C123=“Dead”,“”,VLOOKUP(C$6,definc_table,5)) |
| Def Inc Net of Inc | =IF(C123=“Dead”,“”,VLOOKUP(C$6,definc_table,10)) |
| Tax | |
| Qualified Plan | =IF(C123=“Dead”,“”,VLOOKUP(C$6,qp_table,5)) |
| QP Net of Inc Tax | =IF(C123=“Dead”,“”,VLOOKUP(C$6,qp_table,11)) |
| Other 1 | =IF(C123=“Dead”,“”,VLOOKUP(C$6,in_table,7)) |
| Equities | =IF(C123=“Dead”,“”,VLOOKUP(C$6,Equities!$A$8:$H$ |
| | 37,8)) |
| Business Stocks | =IF(C123=“Dead”,“”,VLOOKUP(C$6,'Business |
| | Stocks'!$A$8:$F$37,6)) |
| Real Estate | =IF(C123=“Dead”,“”,VLOOKUP(C$6,Realestate_table,6)) |
| Other 2 | =IF(C123=“Dead”,“”,VLOOKUP(C$6,otherrevals,4)) |
| Tax Free | =IF(C123=“Dead”,“”,VLOOKUP(C$6,TF_table,7)) |
| Group Term Life | =IF(C123=“Dead”,“”,VLOOKUP(C$6,attable1,10)) |
| Cash Value | =IF(C123=“Dead”,“”,VLOOKUP(C6,'Non ILIT |
| | INS'!$A$7:$H$35,8)) |
| Misc Debt | =IF(C123=“Dead”,“”,VLOOKUP(C$6,debttable,5)*−1) |
| Gross Estate | =IF(C123=“Dead”,“”,SUM(C56:C79)−C61−C58−C77) |
| Estate Exemption | =IF(C123=“Dead”,“”,IF(couplesingle=“couple”,IF(coupled |
| | ed=“No”,VLOOKUP(Totals!C7,exemption,2),IF(C121=0, |
| | VLOOKUP(Totals!C7,exemption,3),VLOOKUP(Totals!C |
| | 7,exemption,2))),VLOOKUP(Totals!C7,exemption,3))) |
| Tax | =IF(C123=“Dead”,“”,IF(HLOOKUP(C54,newrates,3)0,0, |
| | (IF(C81−C83<=0,0,VLOOKUP(C81− |
| | C83,estate_tax,2)+((VLOOKUP(C81− |
| | C83,estate_tax,3)*HLOOKUP(C54,newrates,2)/0.55)*(C8 |
| | 1−C83−VLOOKUP(C81−C83,estate_tax,1))))))*−1) |
| Investment Outlays | =IF(C123=“Dead”,“”,VLOOKUP(C6,Ilit_table,3)) |
| Cash Value | =IF(C123=“Dead”,“”,VLOOKUP(C6,BBIT!$A$5:$D$34,4)) |
| CST | =IF(C123=“Dead”,“”,VLOOKUP(C$6,attable2,7)) |
| Other | =IF(C123=“Dead”,“”,VLOOKUP(C$6,Deferred_tableta,5)) |
| Net | =IF(C123=“Dead”,“”,+C81+C85+C87+C90+C92) |

Total Estate table 36 of Totals sheet 30 includes a row 50 containing a net estate value for each year in the planned range of years.

As will be understood by those skilled in the art of spreadsheet programming, the “D” column and subsequent year columns of Spendable Income table 34 and Total Estate table 36 use formulas similar to the “C” column formulas provided in Tables 1 and 2 above.

Age table 52, seen in FIG. 3G, uses information provided by each participant to provide a thirty-year timeline. The participant provides a start age and a projected death age in a Data sheet described below. These values provide the basis for determining the age of each participant as indicated in rows 54 and 56 and a “Death” or “No Death” flag indicated in row 58 for each year during the timeline.

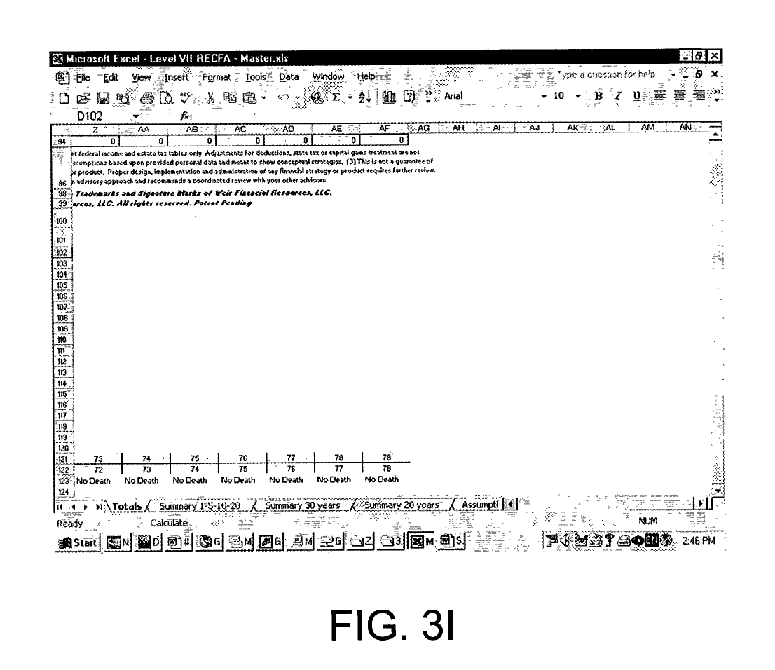

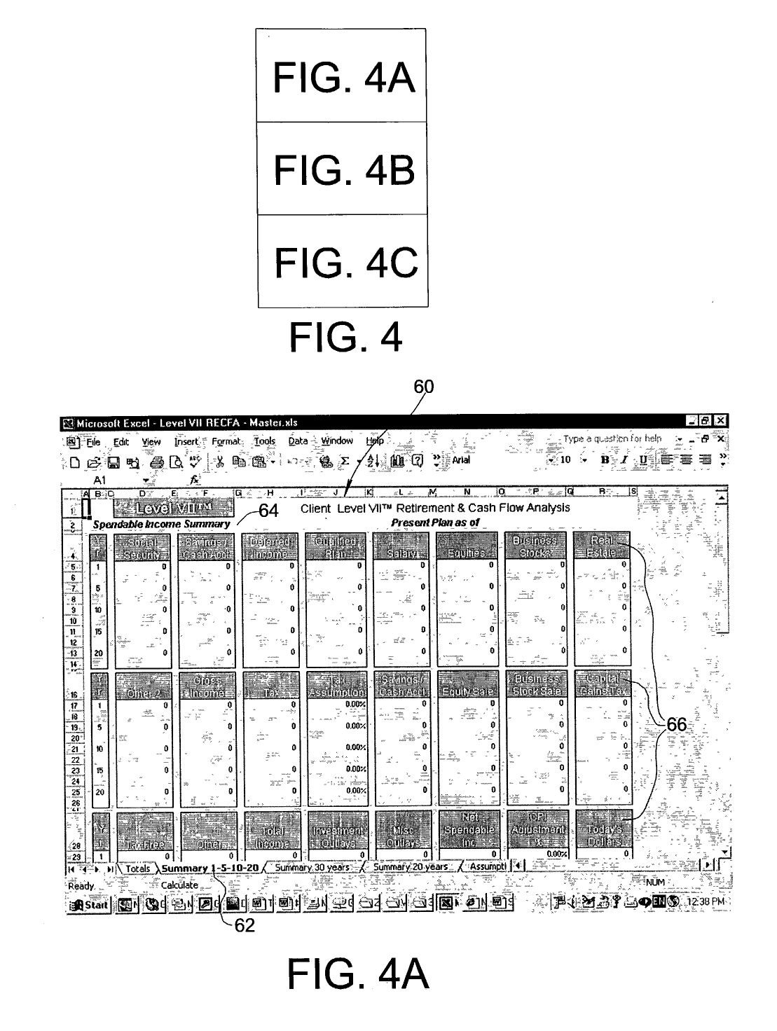

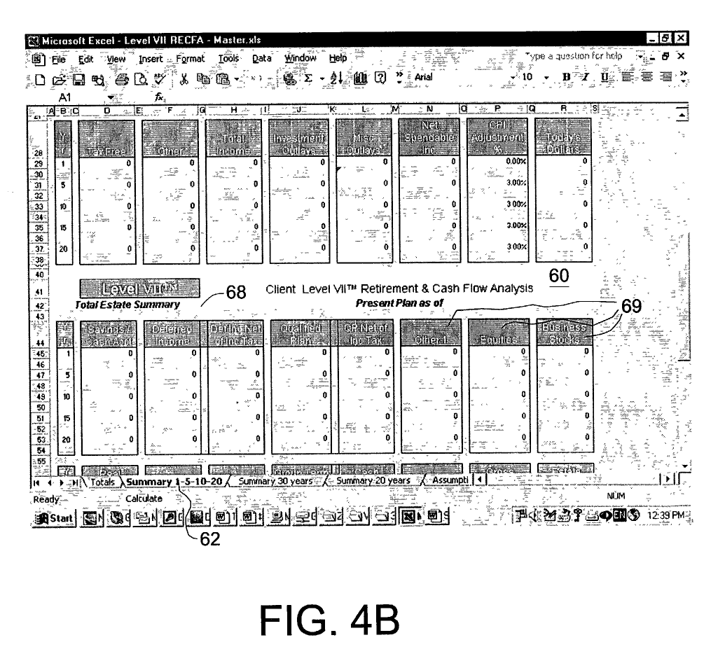

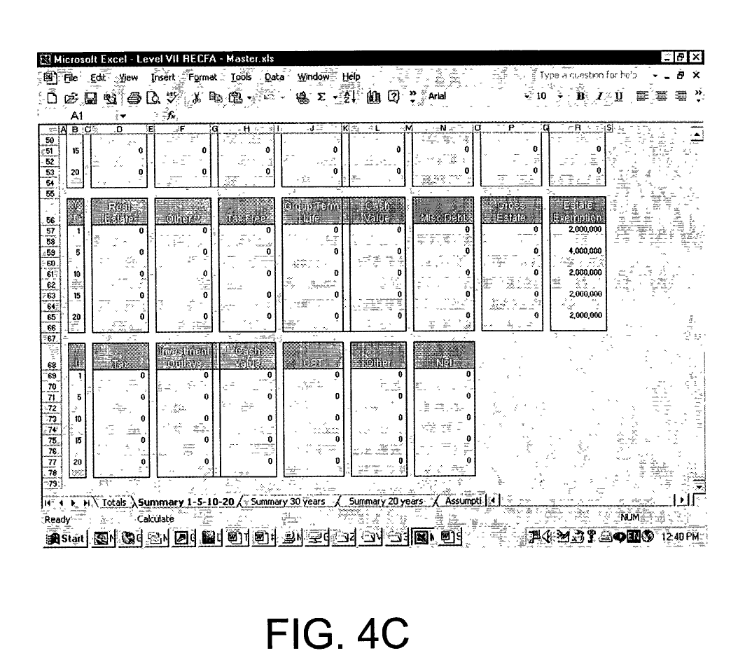

Summary 1-5-10-20 Sheet. A Summary 1-5-10-20 sheet of the present invention is shown in FIG. 4 and designated generally by reference numeral 60. Summary 1-5-10-20 sheet 60 includes a graphical icon tab 62 and provides selected data from Totals sheet 30 in a different format. More specifically, Summary 1-5-10-20 sheet has a Spendable Income Summary portion 64 including a plurality of one-dimensional, category specific tables 66 giving corresponding values at plan year one, plan year five, plan year ten, plan year fifteen, and plan year twenty. Summary 1-5-10-20 sheet further has a Total Estate Summary portion 68 including a plurality of one-dimensional, category specific tables 69 giving corresponding values at plan year one, plan year five, plan year ten, plan year fifteen, and plan year twenty.

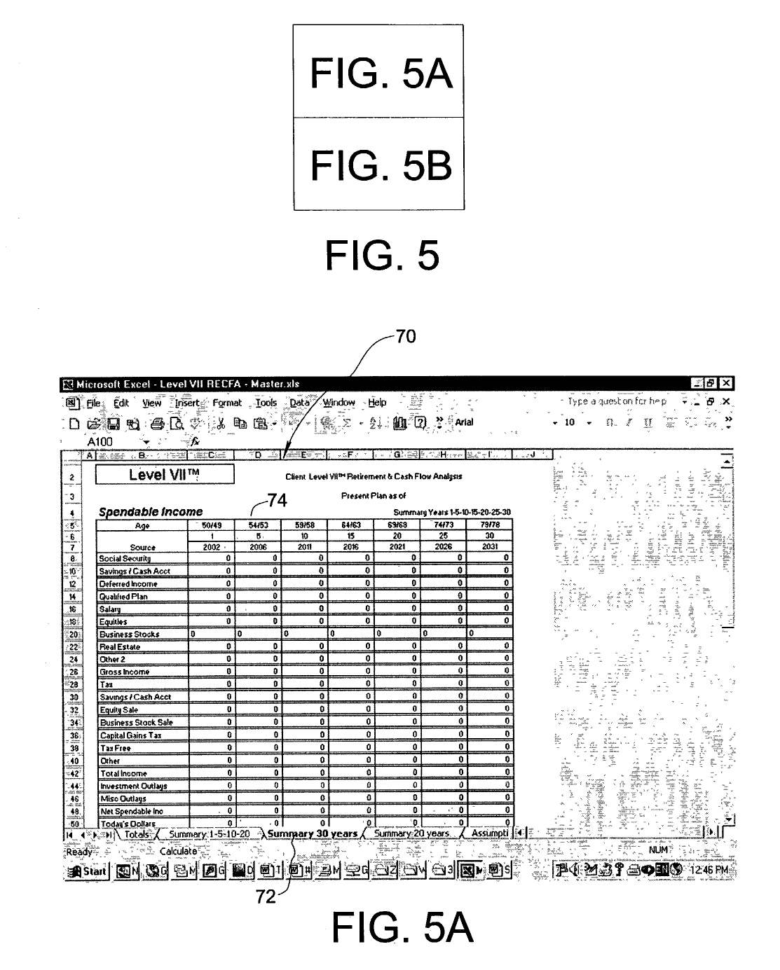

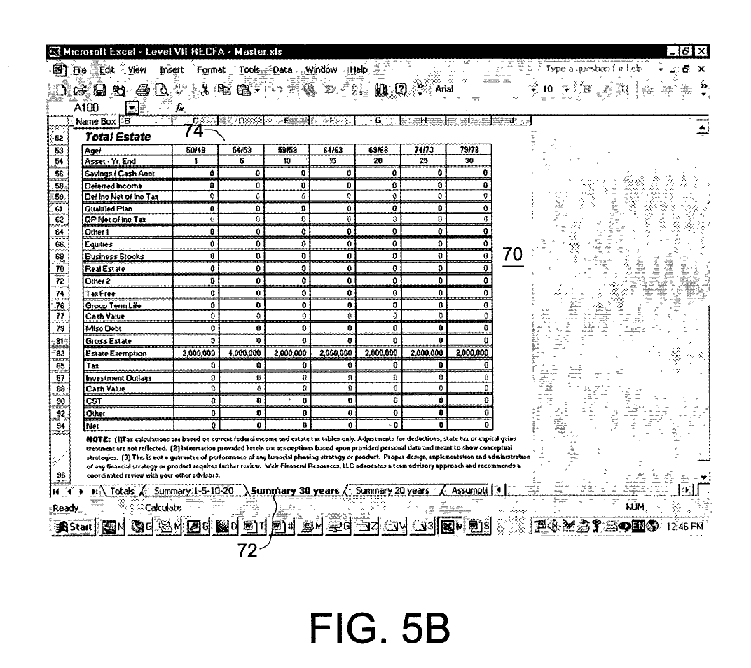

30-year Summary Sheet. FIG. 5 shows a 30-year Summary sheet 70 of the present invention for summarizing selected data from Totals sheet 30. 30-year Summary sheet 70 includes a graphical icon tab 72, a Spendable Income summary table 74 and a Total Estate summary table 76. Tables 74 and 76 are similar in format to the corresponding tables 34 and 36 of Totals sheet 30, however columns are limited to plan year one, plan year five, plan year ten, plan year fifteen, plan year twenty, plan year twenty five, and plan year thirty.

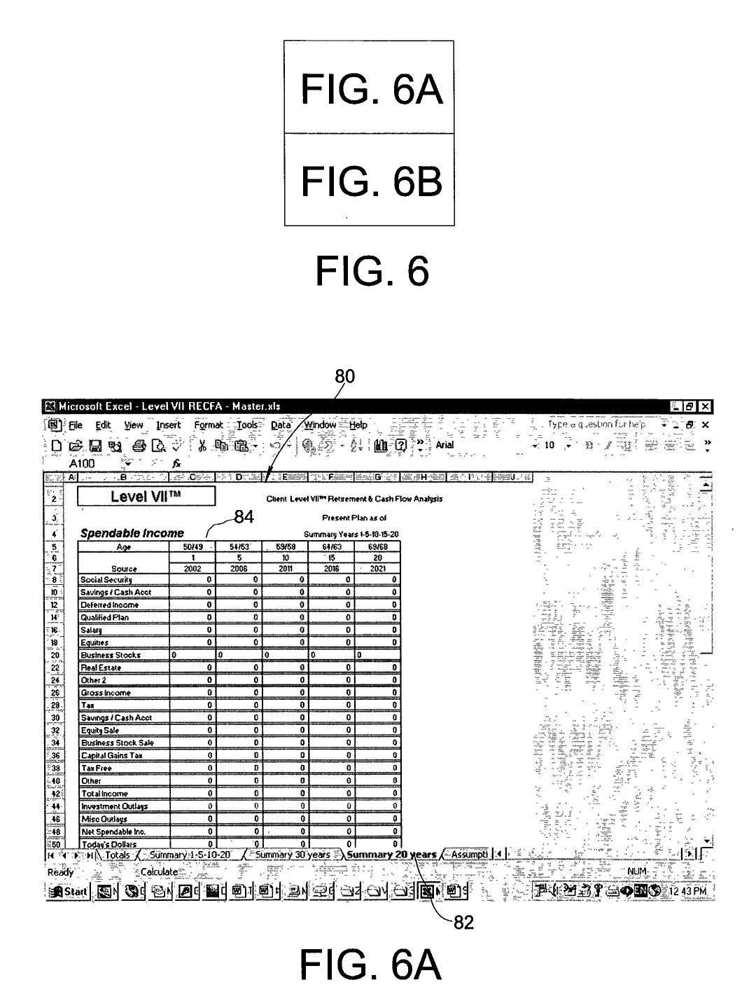

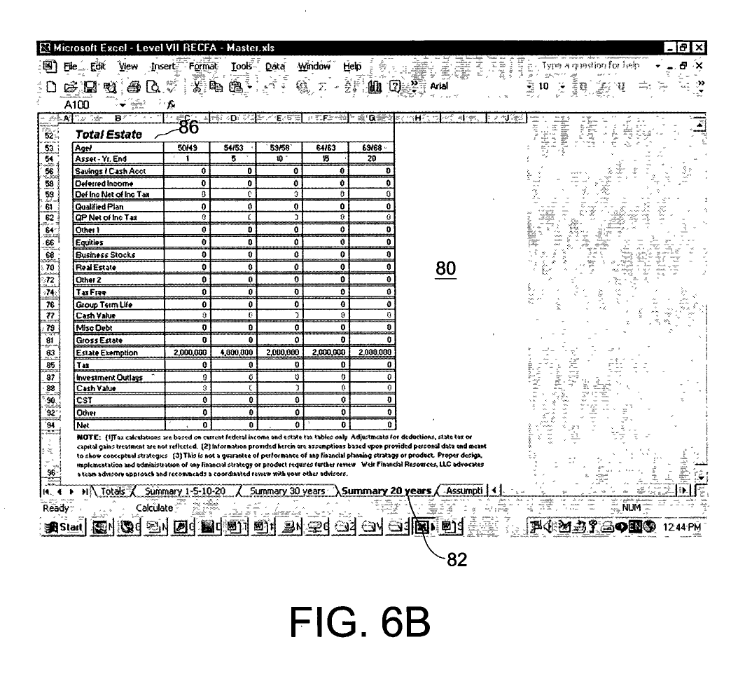

20-year Summary Sheet. FIG. 6 shows a 20-year Summary sheet 80 of the present invention for summarizing selected data from Totals sheet 30. 20-year Summary sheet 80 includes a graphical icon tab 82, a Spendable Income summary table 84 and a Total Estate summary table 86. Tables 84 and 86 are similar in format to the corresponding tables 34 and 36 of Totals sheet 30 and tables 74 and 76 of 30-year Summary sheet 70, however columns are limited to plan year one, plan year five, plan year ten, plan year fifteen, and plan year twenty.

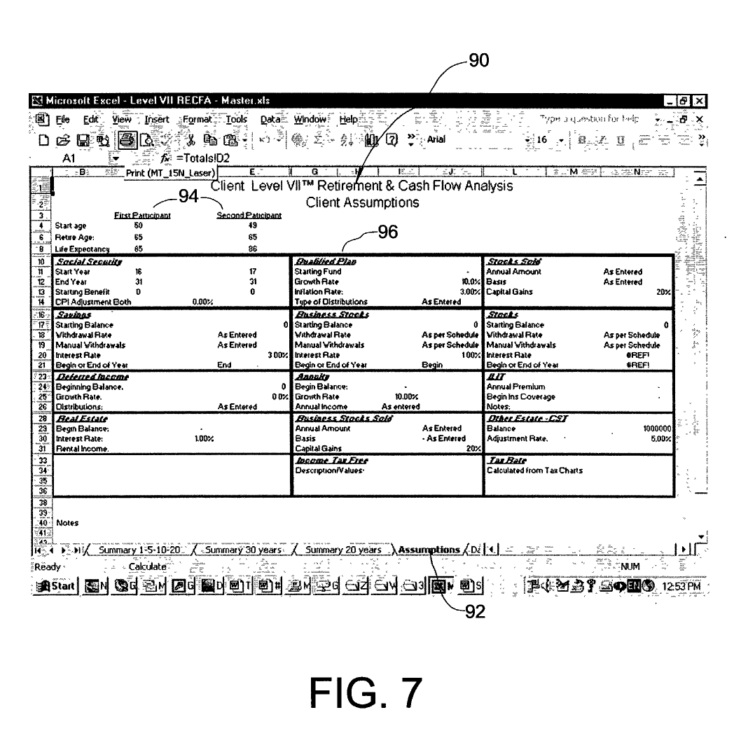

Assumptions Sheet. Reference is now made to FIG. 7 showing an Assumptions sheet 90 of the present invention. Assumptions sheet 90 is displayed by clicking a corresponding graphical icon tab 92 and serves to display input values and constants used throughout the entire program. Assumptions sheet 90 is “read only” and may be printed for information purposes. No changes can be made to the listed data through the Assumptions sheet. Assumptions sheet 90 includes participant tables 94 listing the start age, retirement age, and projected death age of each participant. Assumptions sheet 90 also includes a snapshot list 96 of data and constants assumed for a variety of financial categories as shown.

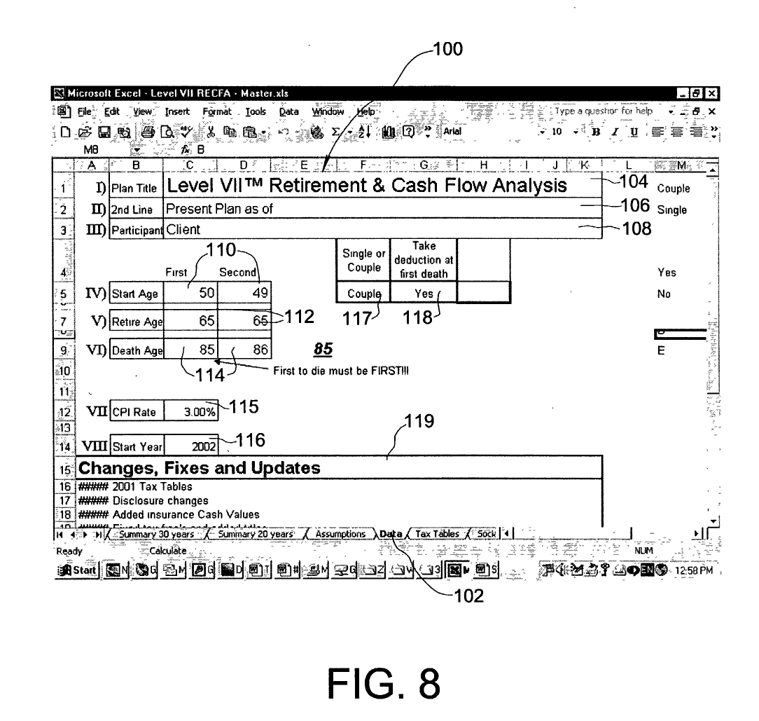

Data Sheet. FIG. 8 shows a Data sheet 100 of the present invention used for inputting basic participant plan information. Data sheet 100 is similar to the other user interface sheets in that it includes a graphical icon tab 102. Data sheet 100 includes a plurality of data entry boxes as follows: box 104 for entering a plan title, box 106 for entering a continuation of the plan title, box 108 for entering a participant name, boxes 110 for entering the start age of one or two participants, boxes 112 for entering the retirement age of one or two participants, boxes 114 for entering projected death ages of one or two participants, the first participant being the first projected to die, box 115 for entering a consumer price index rate, box 116 for entering a start year for the plan timeline, box 117 for entering “single” or “couple” to determine whether one or two participants are involved, and box 118 for entering “yes” or “no” in regard to whether an estate tax deduction should be taken at the death of the first participant. Data sheet 100 also preferably includes a notes portion 119 for entering software revision information.

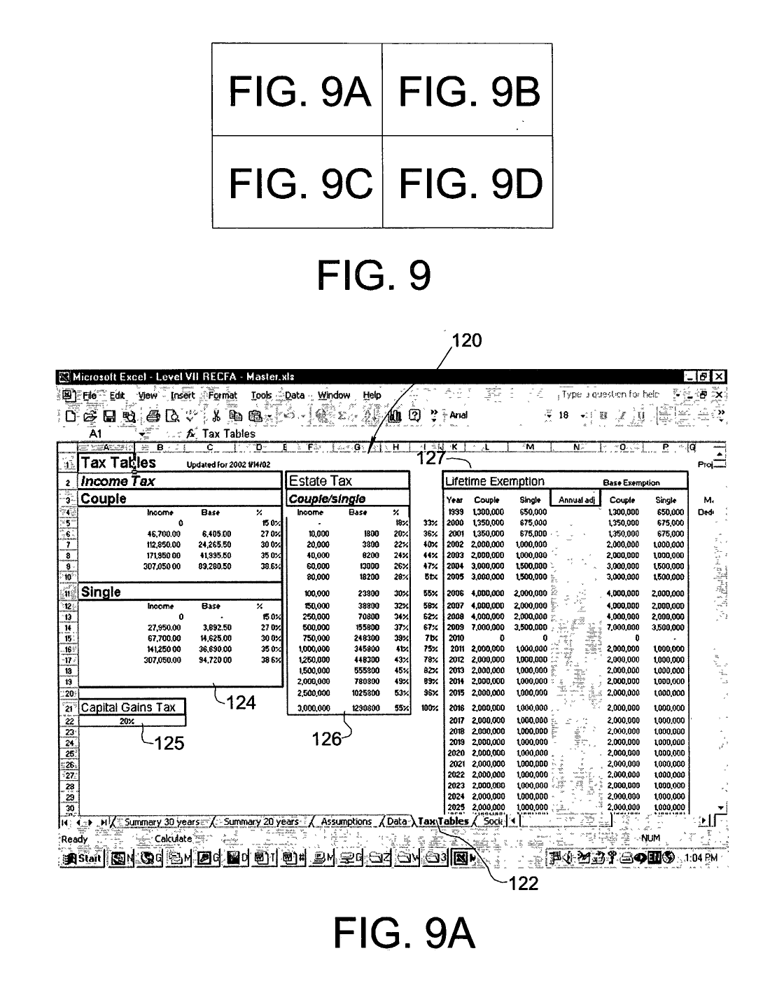

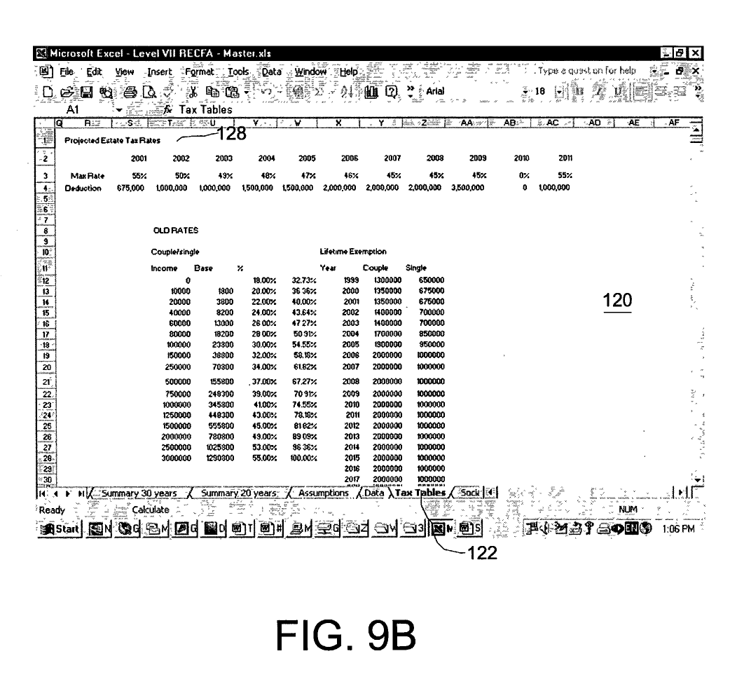

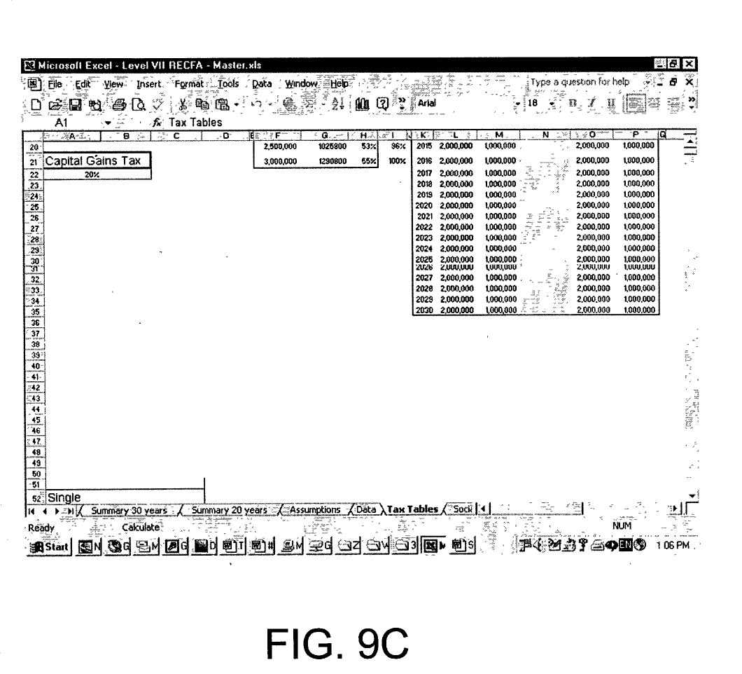

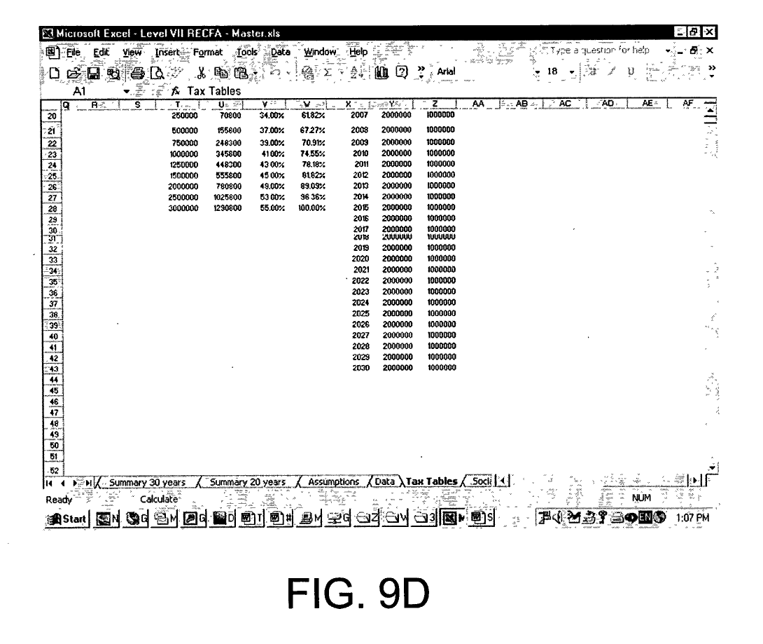

Tax Table Sheet. A financial planner or other user can enter currently applicable tax rates and tax information through a Tax Table sheet 120 accessed by clicking a graphical icon tab 122, as seen in FIG. 9. Tax Table sheet 120 is shown as including an income tax table 124 having information for both single (object name “singleit”) and couple (object name “inctax”) filings, a capital gains tax rate box 125 for receiving and storing the capital gains tax rate, an estate tax table 126, an actual/projected lifetime estate tax exemption table 127 (object name “exemption”) for both single and couple filings, and a projected estate tax rate table 128 (object name “newrates”). The information in Tax Table sheet 120 should be updated by a financial professional as necessary to keep this information current and maintain agreement with applicable tax laws.

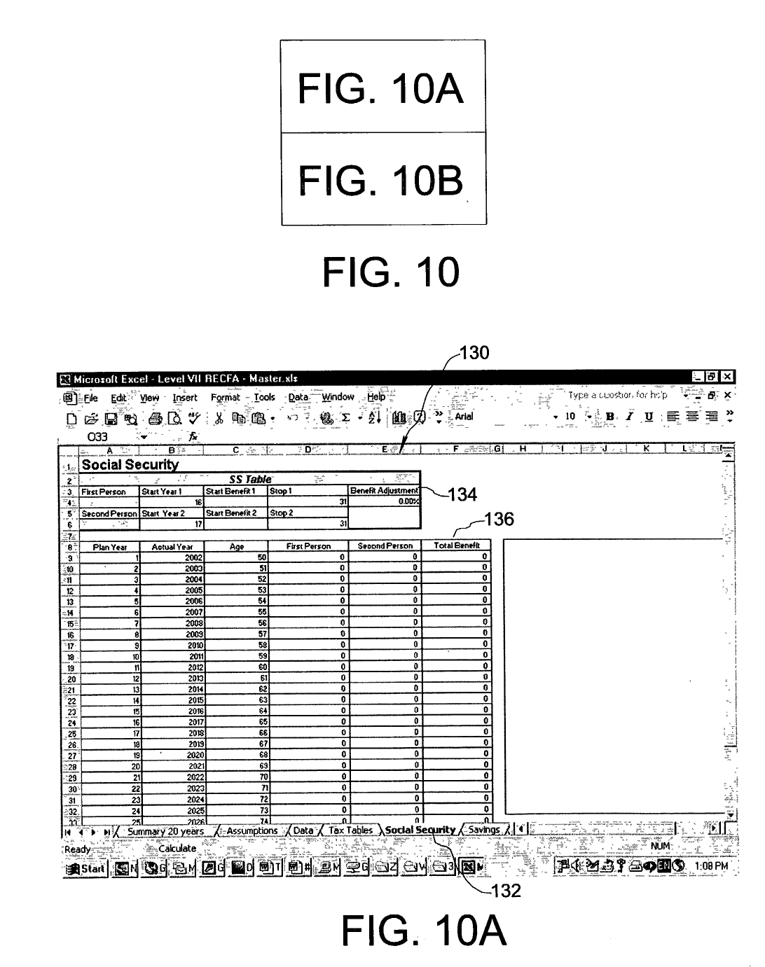

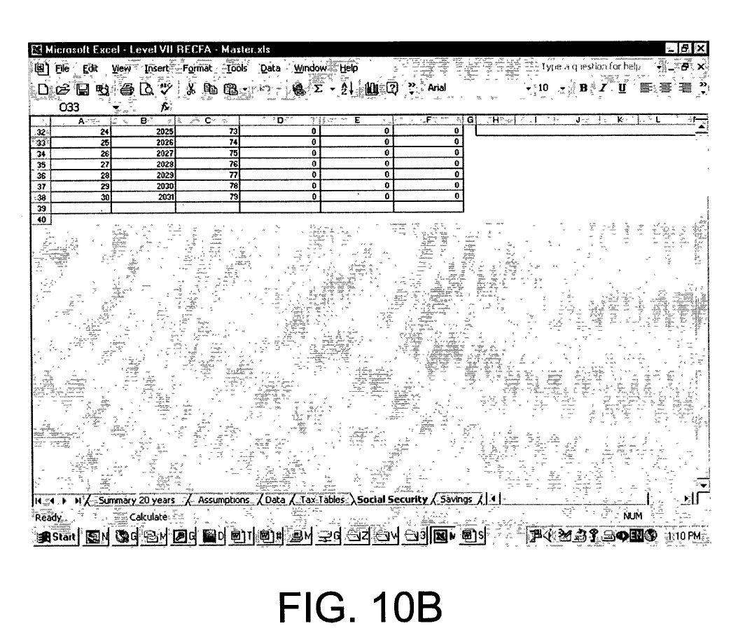

Social Security Sheet. Starting with a Social Security sheet 130 shown in FIG. 10, the software program implemented in accordance with the present invention provides a plurality categorized sheets for receiving and calculating information from which the spendable income and total estate values appearing in Totals sheet 30, Summary 1-5-10-20 sheet 60, 30-year Summary sheet 70, and 20-year Summary sheet 80 are calculated. Social Security sheet 130 includes a graphical icon tab 132, a social security parameter table 134, and a social security benefits table 136 (object name “sstable”). For each participant, the user enters into social security parameter table 134 the plan year that social security benefits start, a corresponding starting benefit amount, an assumed plan year when social security benefits stop, and an assumed accrual rate of the social security benefit. Social security benefits table 136 provides the following columns of timeline information:

Year—Plan years 1-30 (not to be changed).

Actual Year—Actual calendar year based on start year entered in box 116 of Data sheet 100.

Age—Age of older participant based on start age entered in box 110 of Data sheet 100.

First Person—Social Security benefit amount of first participant beginning in the start year with the starting benefit amount entered in social security parameter table 134. The amounts for each plan year thereafter are calculated using the assumed accrual rate entered in social security parameter table 134 until the plan year when social security benefits stop for the first participant.

Second Person—Social Security benefit amount of second participant beginning in the start year with the starting benefit amount entered in social security parameter table 134. The amounts for each plan year thereafter are calculated using the assumed accrual rate entered in social security parameter table 134 until the plan year when social security benefits stop for the second participant.

Total Benefit—First person benefit plus second person benefit equals total benefit.

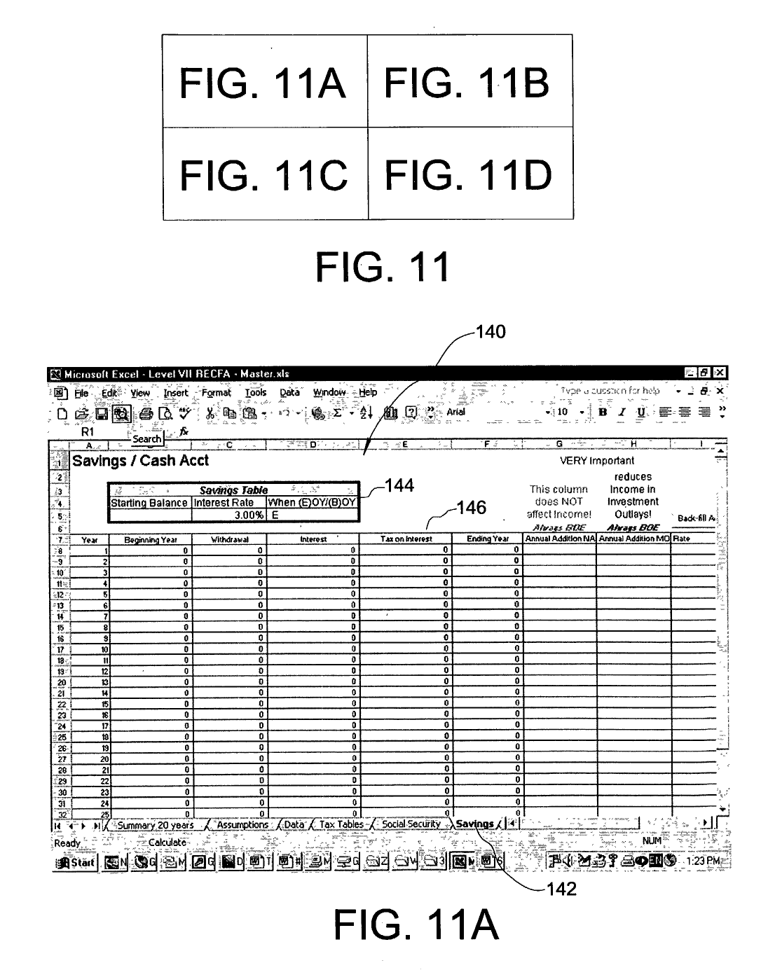

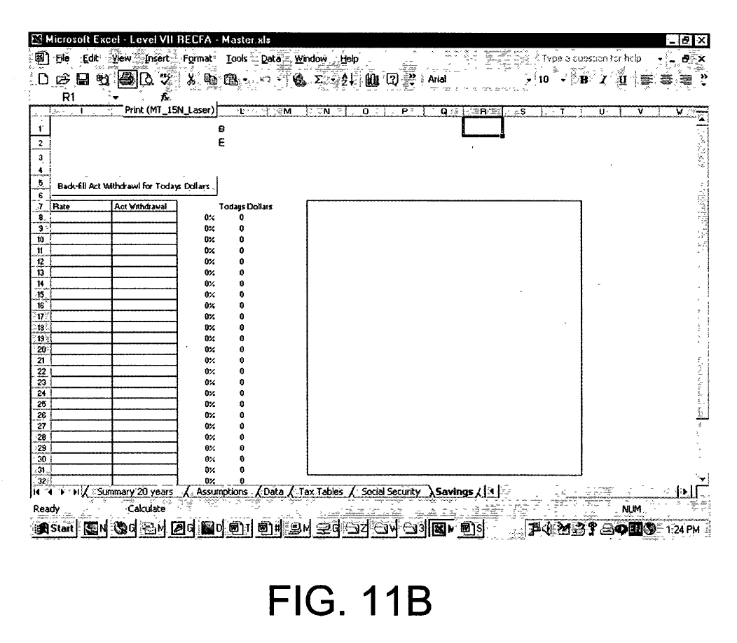

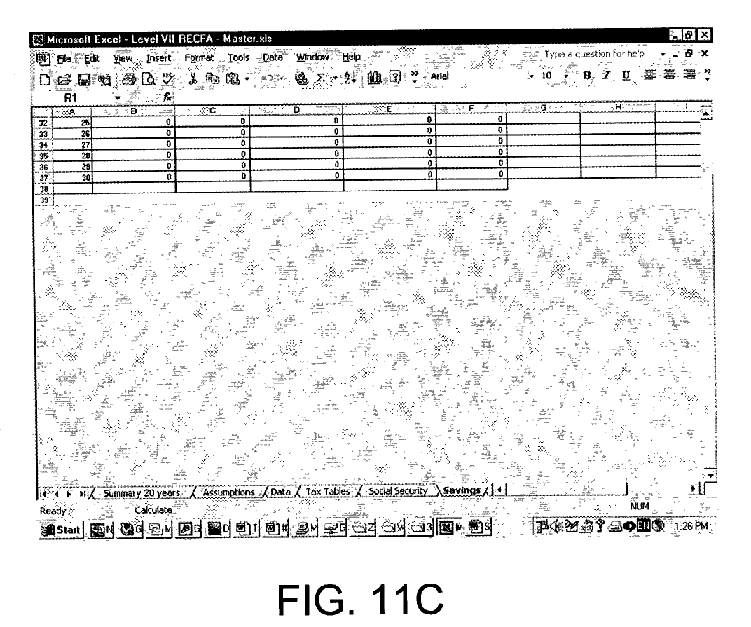

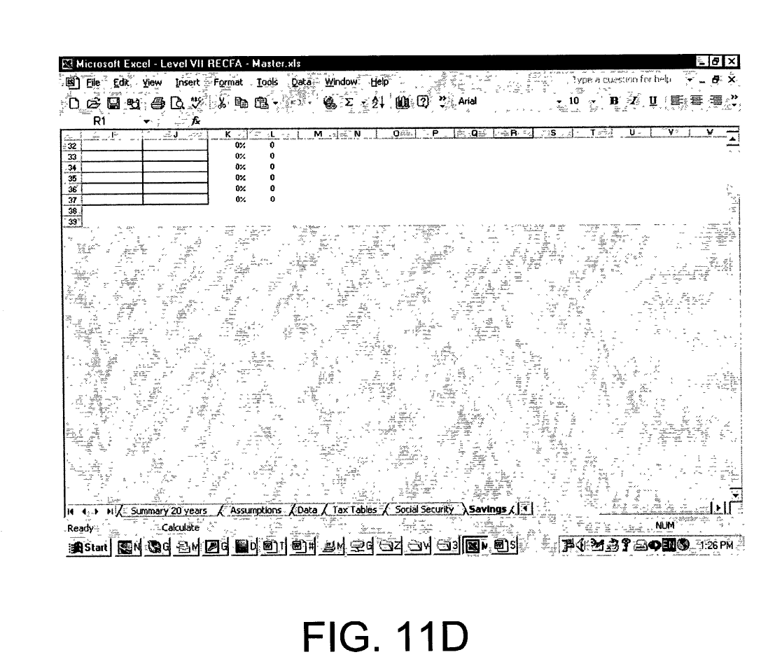

Savings Sheet. Participant savings and cash account amounts are tracked by a Savings sheet 140 having a graphical icon tab 142 as illustrated in FIG. 11. Savings sheet 140 includes a savings parameter table 144 for entering a starting account balance, an interest rate, and “B” or “E” to indicate whether benefits are payable at the beginning of the year or the end of the year. A savings account table 146 (object name “savings_table”) includes the following columns of timeline information:

Year—Plan years 1-30 (not to be changed).

Beginning Year—Savings Balance at the beginning of the plan year.

Withdrawal—Amount calculated from either the Rate or Act Withdrawal column described below. The need for two referenced columns is to utilize Excel's backsolve feature to assist in solving for a specific total income level. When the backsolve feature is used, the backsolve number is placed in the Act Withdraw column. All tables that affect total income have this feature.

Savings Interest—Annual interest accrual using the interest rate entered into savings parameter table 144.

Ending Year—End of year savings account balance.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30.

Rate—This column is used to schedule withdrawal of an amount equal to a fixed percentage of savings for any/all year(s) as income.

Act Withdrawal—Actual annual withdrawal amount from savings to be credited to income. Any entry in this column will override the Rate column entry for the year entered.

Today 's Dollars—This amount equals the Consumer Price Index adjusted value, and is calculated in the CPI Adjustment table for each year from the Total Income row on the Spendable Income table 34 of Totals sheet 30. This column is used as a reference when using the Excel backsolve feature, and allows projection of future income in current year dollars.

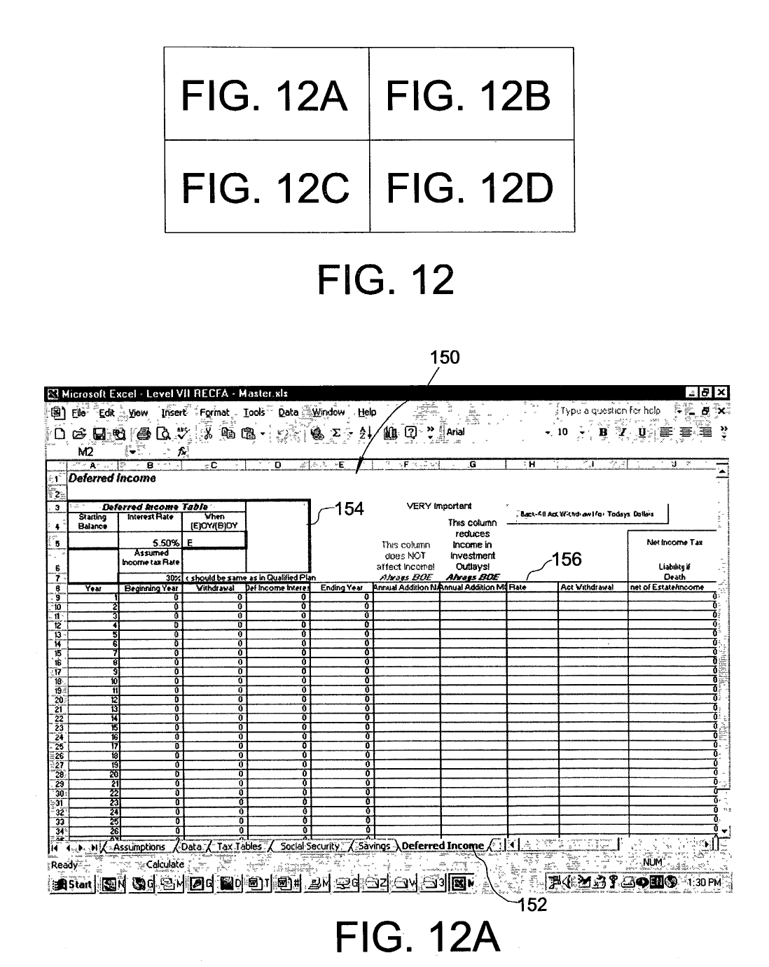

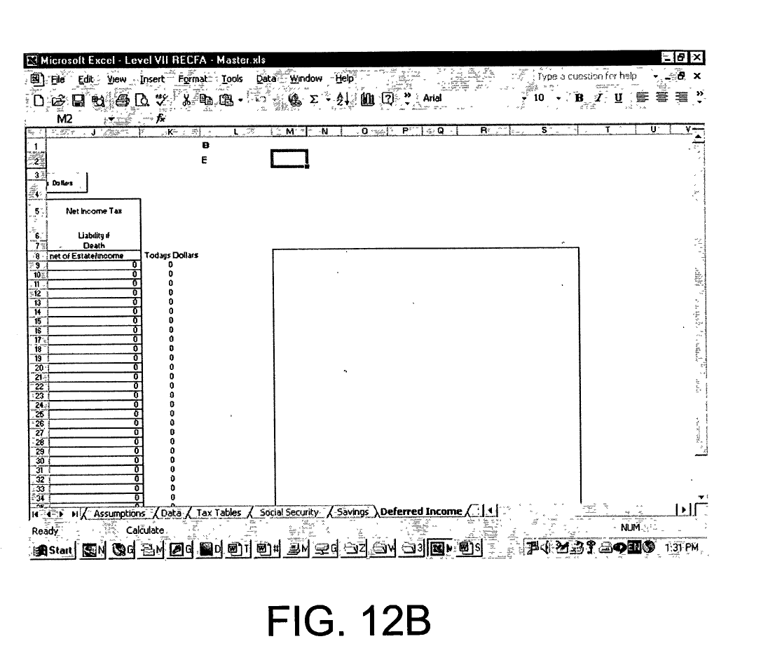

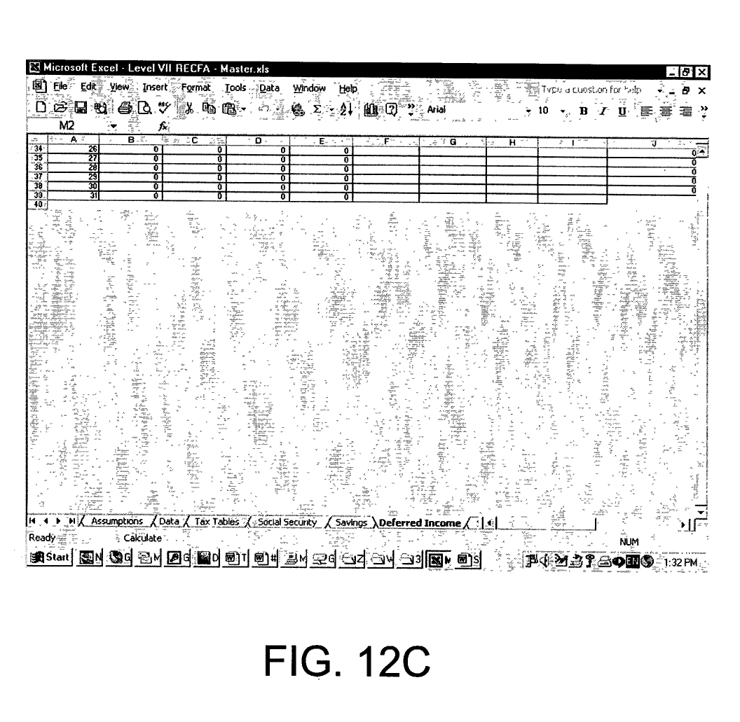

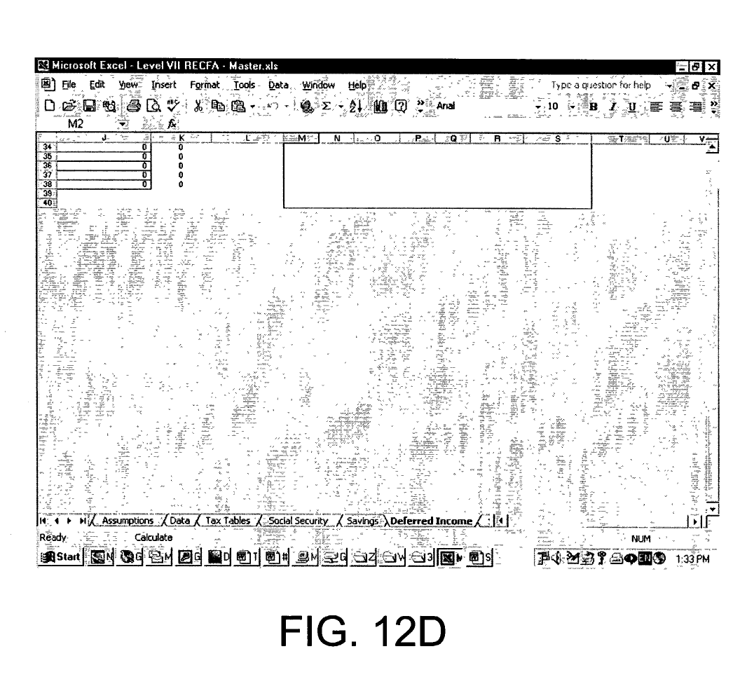

Deferred Income Sheet. FIG. 12 shows another categorized sheet of the present invention, namely a Deferred Income sheet 150. Deferred Income sheet 150 has a corresponding graphical icon tab 152, deferred income parameter table 154, and a deferred income table 156 (object name “definc_table”). Deferred income parameter table 154 receives a starting balance, an interest rate, “B” or “E” to indicate whether benefits are payable at the beginning of the year or the end of the year, and an assumed income tax rate, which should agree with the assumption made with respect to the Qualified Plan sheet described below. Deferred income table 156 includes the following columns:

Year—Plan years 1-30 (not to be changed).

Beginning Year—Deferred Income balance at the beginning of the plan year.

Withdrawal—Amount calculated from either the Rate or Act Withdrawal column described below. The need for two referenced columns is to utilize Excel's backsolve feature to assist in solving for a specific total income level. When the backsolve feature is used, the backsolve number is placed in the Act Withdraw column. All tables that affect total income have this feature.

Def Income Interest—Annual interest accrual using the interest rate entered into the deferred income parameter table 154.

Ending Year—End of year Deferred Income account balance.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Rate—This column is used to schedule withdrawal of an amount equal to a fixed percentage of deferred income for any/all year(s) as income.

Act Withdrawal—Actual annual withdrawal amount from deferred income to be credited to income. Any entry in this column will override the Rate column entry for the year entered.

Net Income Tax Liability—Calculates the income tax due on the remaining value of the deferred income if death occurs using the assumed income tax rate provided in deferred income parameter table 154.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

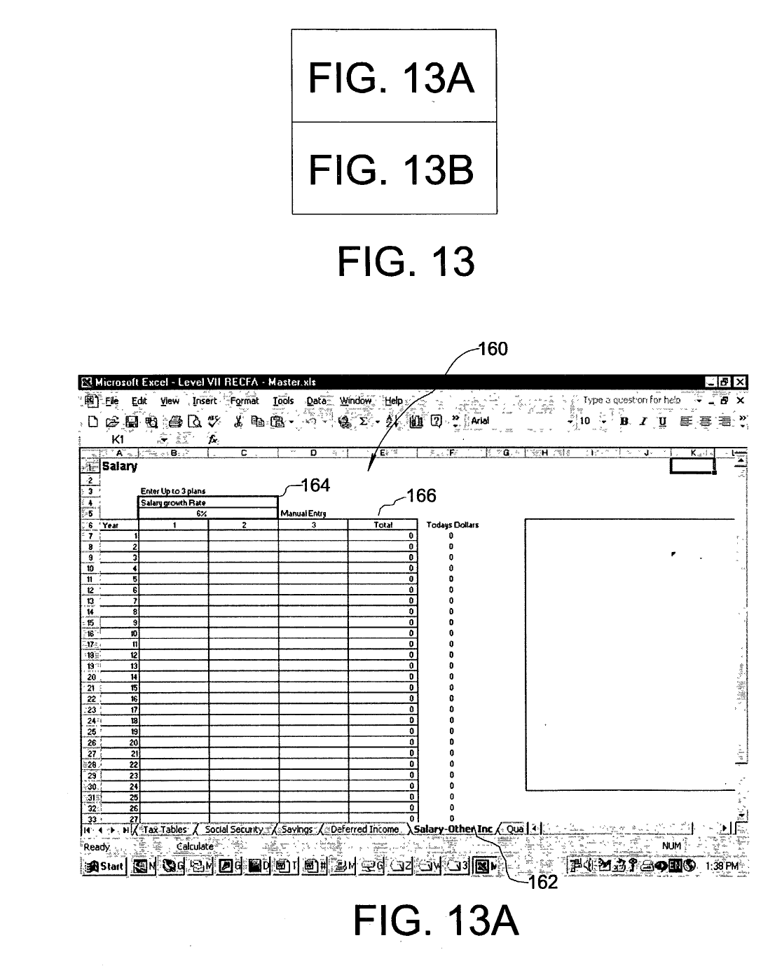

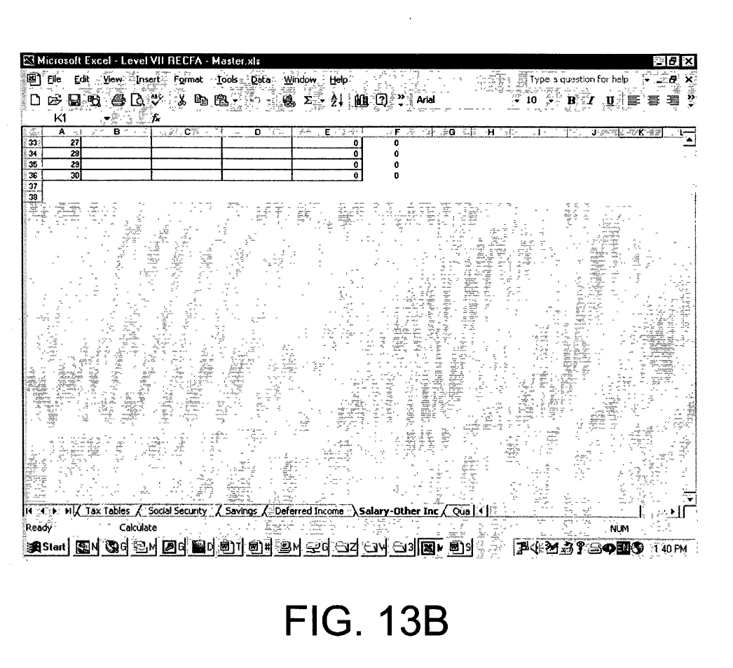

Salary and Other Income Sheet. Referring now to FIG. 13 of the drawings, a Salary and Other Income sheet 160 of the present invention is depicted as including a graphical icon tab 162, a salary parameter table 164, and a salary table 166 (object name “otherincome”). Salary parameter table 164 receives a salary growth rate. Salary table 166 allows data to be entered for up to three income sources and totals those three sources. The income source columns are manually entered, and the only calculation is totaling the income source columns.

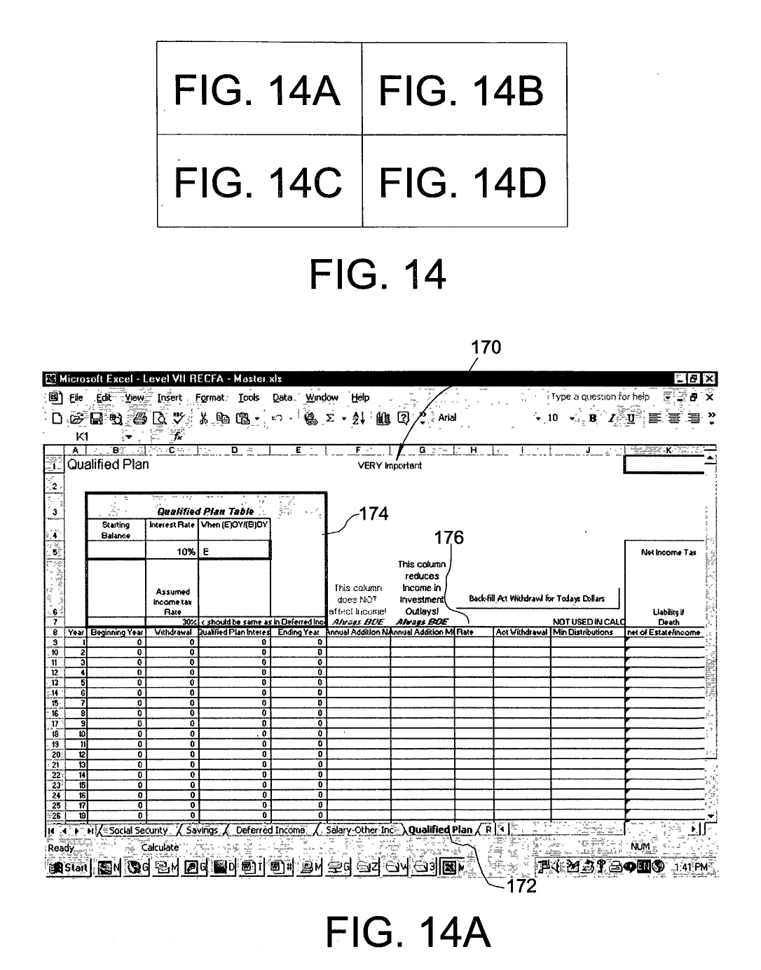

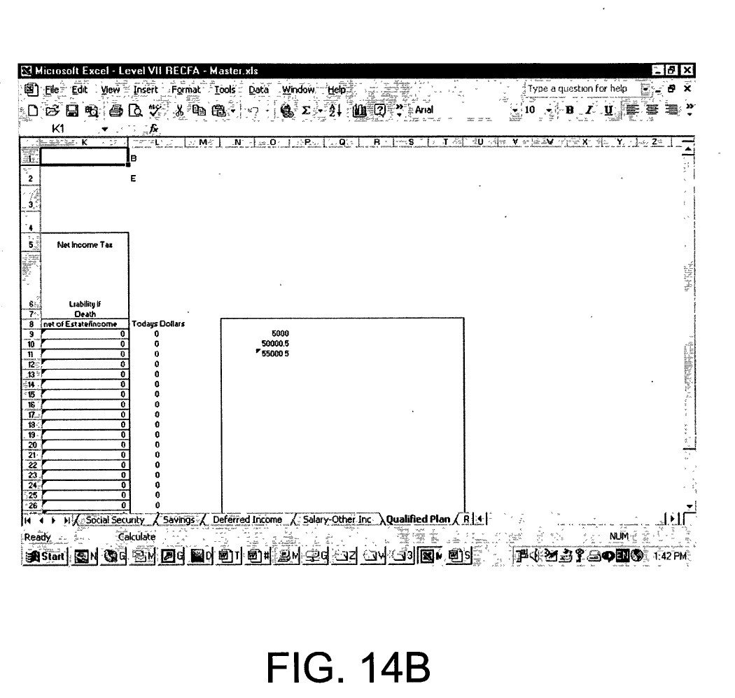

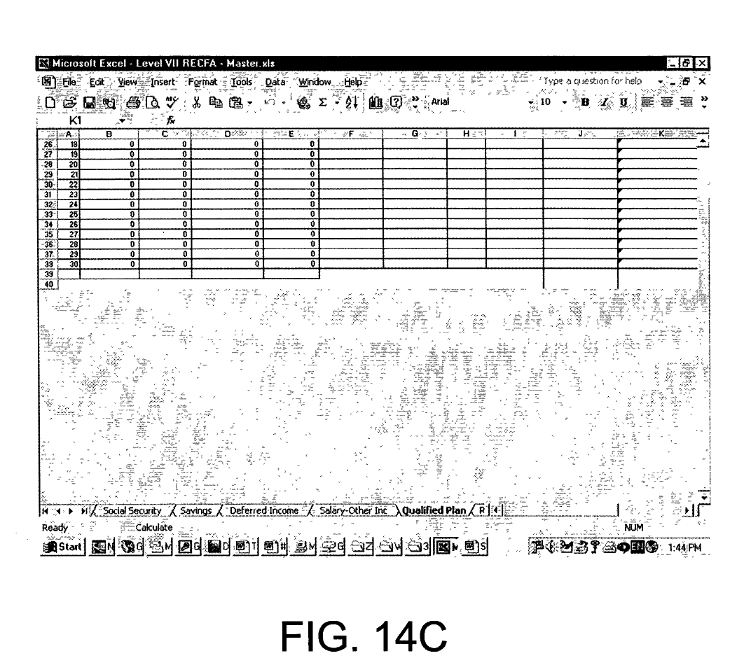

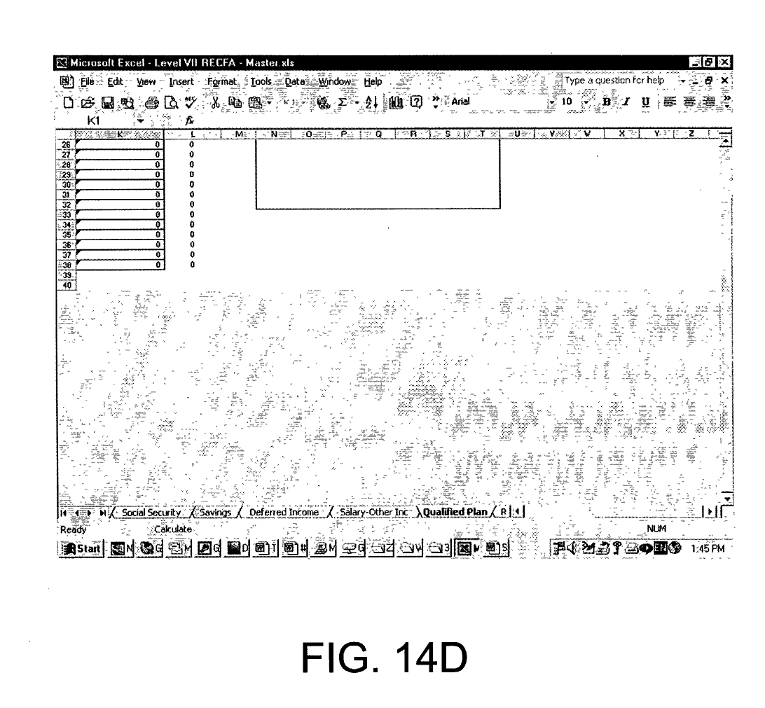

Qualified Plan Sheet. FIG. 14 shows a Qualified Plan sheet 170 of the present invention. Qualified Plan sheet 170 is displayed by clicking a graphical icon tab 172 and includes a qualified plan parameter table 174 as well as a qualified plan table 176 (object name “qp_table”). Qualified plan parameter table 174 receives a starting balance, an interest rate, “B” or “E” to indicate whether benefits are payable at the beginning of the year or the end of the year, and an assumed income tax rate, which should agree with the assumption made with respect to Deferred Income sheet 150 described above. Qualified Plan table 176 includes the following columns:

Year—Plan years 1-30 (not to be changed)

Beginning Year—Qualified plan balance at the beginning of the year.

Withdrawal—Amount calculated from either the Rate or Act Withdrawal column described below. The need for two referenced columns is to utilize Excel's backsolve feature to assist in solving for a specific total income level. When the backsolve feature is used, the backsolve number is placed in the Act Withdraw column. All tables that affect total income have this feature.

Qualified Plan Interest—Annual interest accrual using the interest rate entered into qualified plan parameter table 174.

Ending Year—Qualified plan balance at the end of the year.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Rate—This column is used to schedule withdrawal of an amount equal to a fixed percentage of the qualified plan for any/all year(s) to income.

Act Withdrawal—Actual annual withdrawal amount from the qualified plan credited to income. Any entry in this column will override the Rate column entry for the year entered.

Minimum Distributions—Enter from Leimberg Software Program (a third party program used to calculate qualified plan distributions; see www.leimberg.com) the minimum distribution required on the qualified plan. This amount is to be used as a guide when projecting actual withdrawals from the qualified plan.

Net Income Tax Liability—Calculates the income tax due on the remaining value of the qualified plan due if death occurs using the assumed income tax rate provided in qualified plan parameter table 174

Today 's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

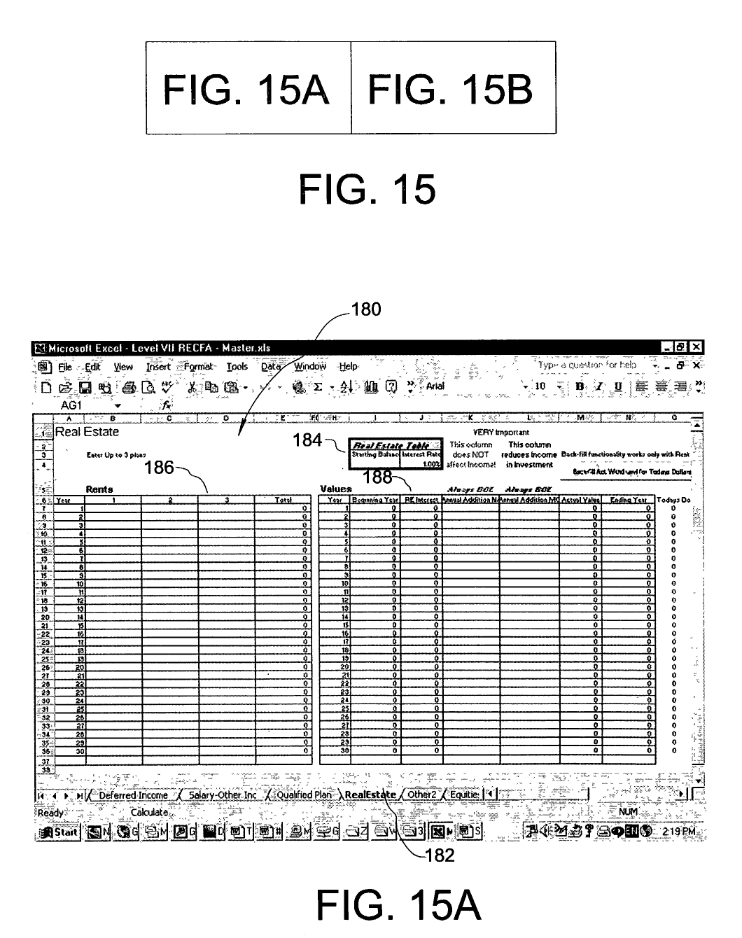

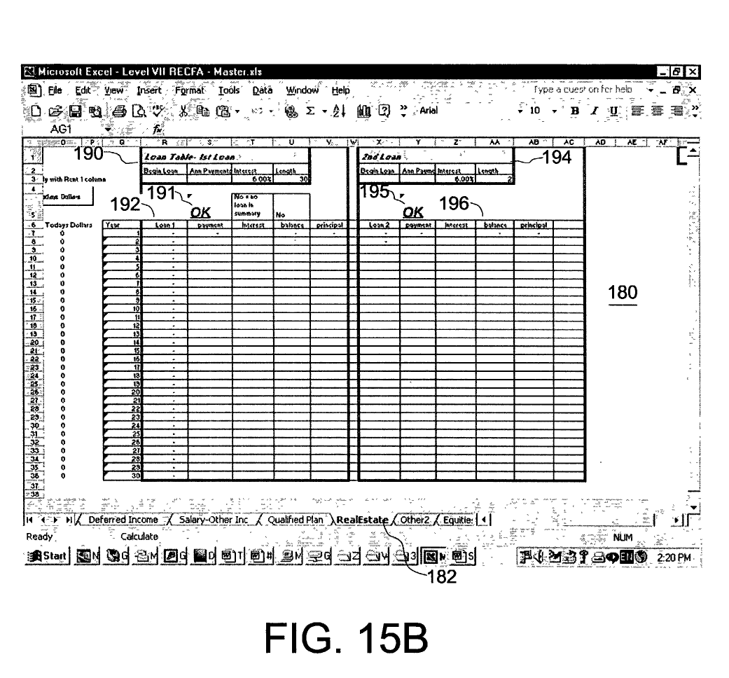

Real Estate Sheet. Another categorized user interface sheet, namely Real Estate sheet 180, is illustrated in FIG. 15 and displayed by clicking a graphical icon tab 182 corresponding thereto. Real estate sheet 180 is used for tracking real estate income and values, and includes a real estate rents table 186 (object name “rents_table”), a real estate values parameter table 184, a real estate values table 188 (object name “Realestate_table”), a first loan parameter table 190, a first loan table 192, a second loan parameter table 194, and a second loan table 196 (object name of tables 192 and 196 combined is “Loantable”).

Real estate rents table 186 is used to enter up to three rental incomes, and includes a column for calculating a total rental income for each plan year. The three rental income columns are manually entered, and no projections are used.

Real estate values table 188 is used in association with real estate values parameter table 184 to project the value of real property during the timeline. Real estate values parameter table 184 receives a starting balance and an applicable interest rate. Real estate values table 188 includes the following columns:

Year—Plan years 1-30 (not to be changed)

Beginning Year—Real Estate balance at the beginning of the year.

RE Interest—Annual interest accrual using the interest rate entered into real estate values parameter table 184.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Actual Value—This amount is a calculation summarizing the Ending Year amount less any loan plus accrued Principal from the Loan Section.

Ending Year—Real Estate balance at the end of the year.

Today 's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

The loan portion of Real Estate sheet 180, best seen in FIG. 15B, projects loan values on real property for two real estate loans, as necessary. The loan portion includes a first loan parameter table 190 and second loan parameter table 194 each receiving a beginning loan value, an annual payments amount, an interest rate, and a length of the loan for a respective first or second loan. A first loan notation 191 appears above first loan table 192 and a second loan notation 195 appears above second loan table 196 to indicate loan status, i.e. “Paid Early”, “OK”, “Loan Not Repaid”, or “Payments Too High”. First loan table 192 and second loan table 196 each include the following columns:

Year—Plan years 1-30 (not to be changed)

Beginning Year—Loan balance at the beginning of the year.

Ann Payment—Annual payment amount from the associated loan parameter table 190 or 194.

Interest—Annual interest accrual using the interest rate entered into the associated loan parameter table 190 or 194.

Balance—Loan balance at the end of the year.

Principal—Principal accrual.

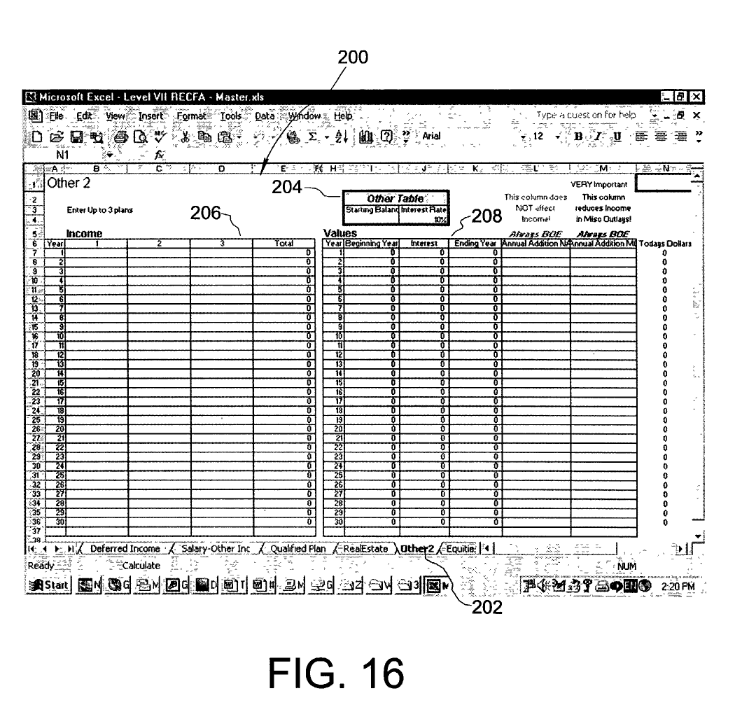

Other2 Sheet. An Other2 sheet 200 of the present invention is shown in FIG. 16 and is displayed by clicking a graphical icon tab 202. Other2 sheet 200 includes an other2 income table 206 (object name “otherrents”), an other2 parameter table 204, and an other2 values table 208 (object name “otherrevals”). Other2 income table 206 is used to enter up to three incomes, and includes a column for calculating a total income for each plan year. The three income columns are manually entered, and no projections are used.

Other2 values table 208 is used in association with other2 values parameter table 204 to project the value of other property during the timeline. Other2 values parameter table 204 receives a starting balance and an applicable interest rate. Other2 values table 208 includes the following columns:

Year—Plan years 1-30 (not to be changed)

Beginning Year—Other2 balance at the beginning of the year.

Interest—Annual interest accrual using the interest rate entered into other2 values parameter table 204.

Ending Year—Other2 balance at the end of the year.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

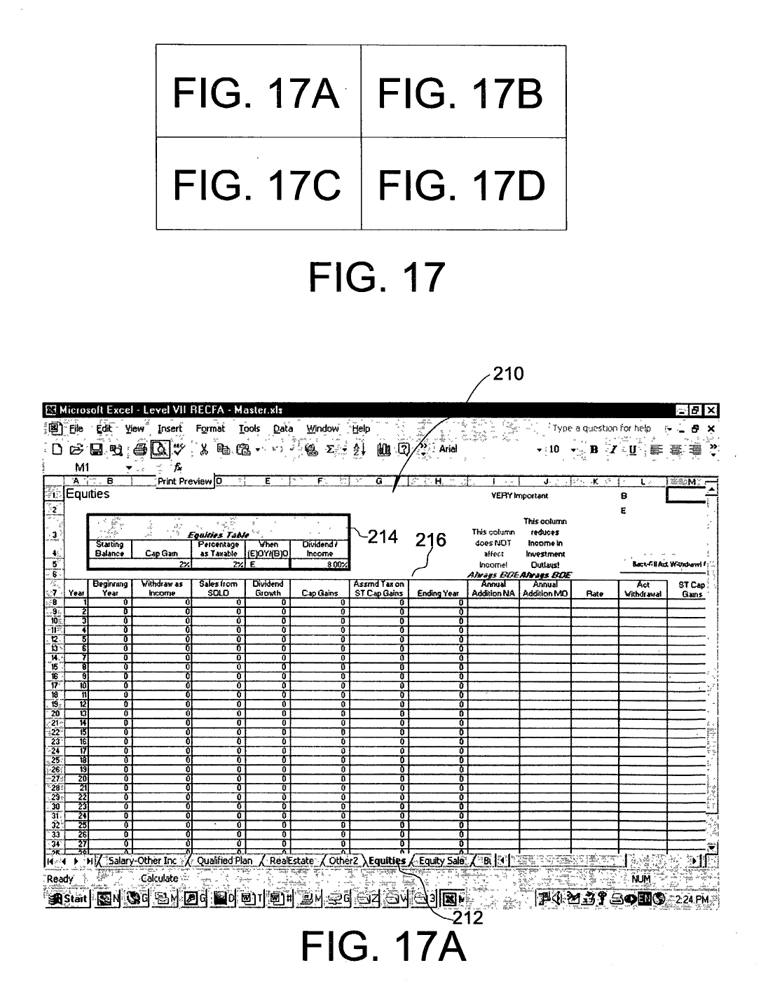

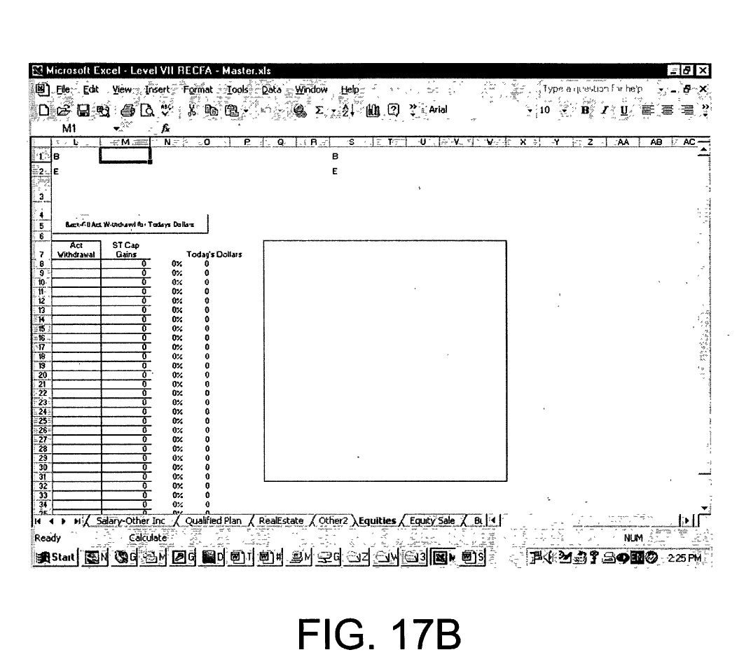

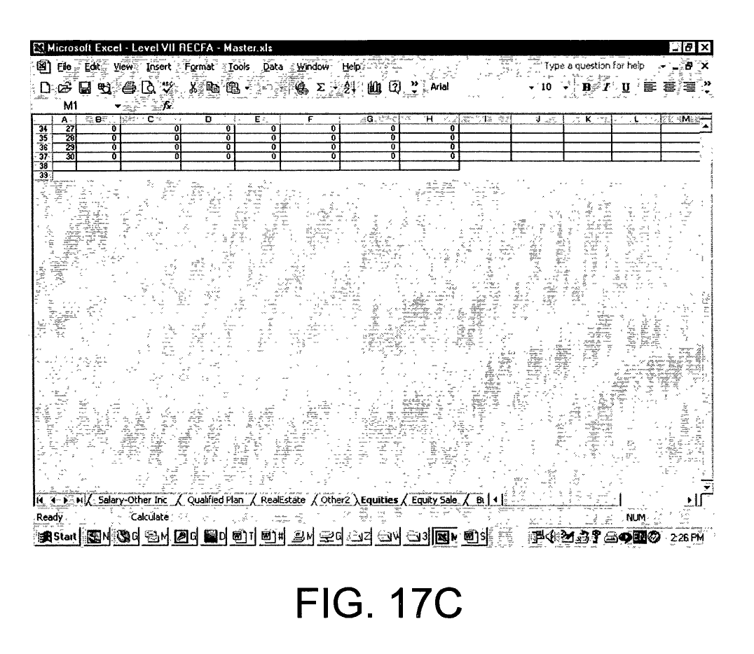

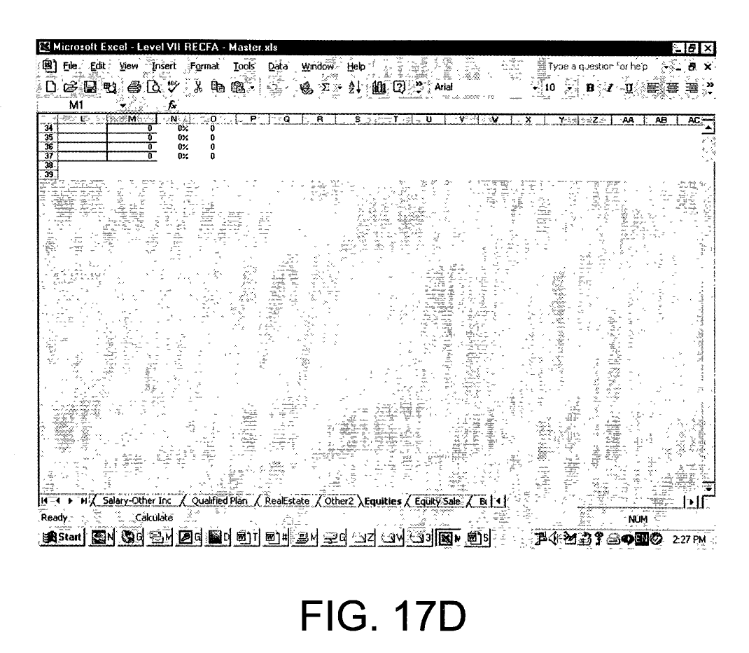

Equities Sheet. FIG. 17 shows an Equities sheet 210 of the present invention that is displayed by clicking an associated graphical icon tab 212. Equities sheet 210 includes an equities parameter table 214 and an equities table 216 (object names “stocks_table” and “EQUITIES”). Equities parameter table 214 receives a starting balance, capital gains growth rate, dividend and income rate, and “B” or “E” to indicate whether benefits are payable at the beginning of the year or the end of the year. Equities table 216 includes the following columns:

Year—Plan years 1-30 (not to be changed)

Beginning Year—Equities balance at the beginning of the year.

Dividend—Amount calculated from either the Rate or Act Withdrawal column described below. The need for two referenced columns is to utilize Excel's backsolve feature to assist in solving for a specific total income level. When the backsolve feature is used, the backsolve number is placed in the Act Withdraw column. All tables that affect total income have this feature.

Sales from Sold—Value of Sold Equities from the equity sale table described hereinafter.

Dividend Growth—Annual dividend accrual using the Dividend/Inc rate entered into the Equity Table.

Cap Gains—annual Cap gains accrual using the Cap Gains rate entered into Equities parameter table 214.

Ending Year—Equities balance at the end of the year.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Rate—This column is used to schedule withdrawal of an amount equal to a fixed percentage of equities for any/all year(s) to income.

Act Withdrawal—Actual annual withdrawal amount from equities to income. Any entry in this column will override the Rate column entry for the year entered.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

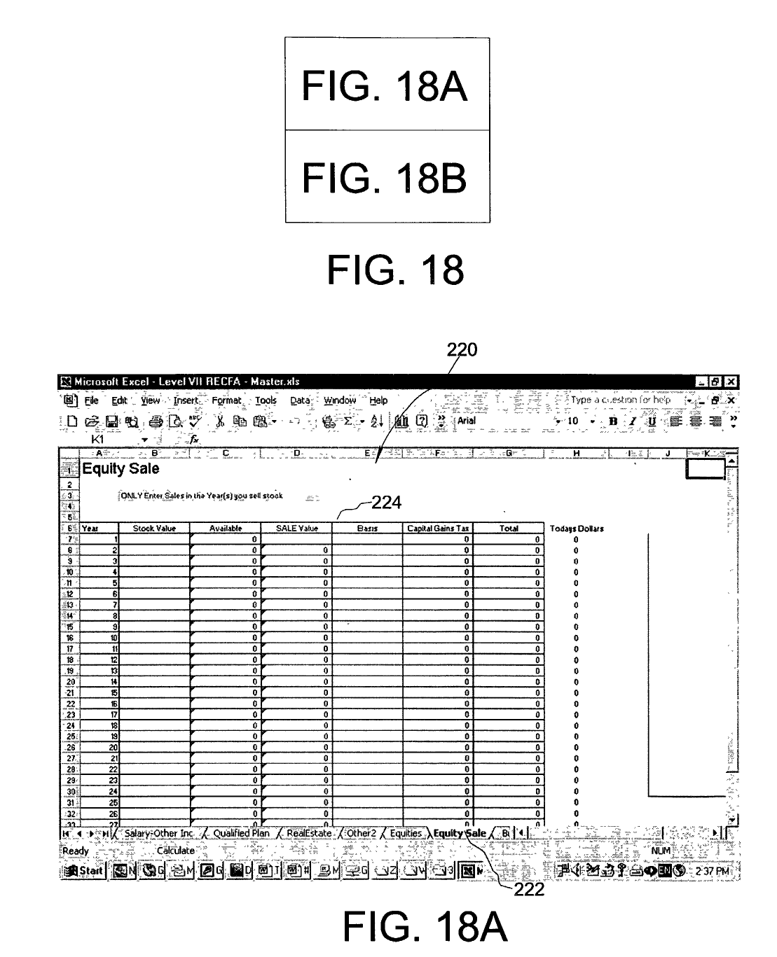

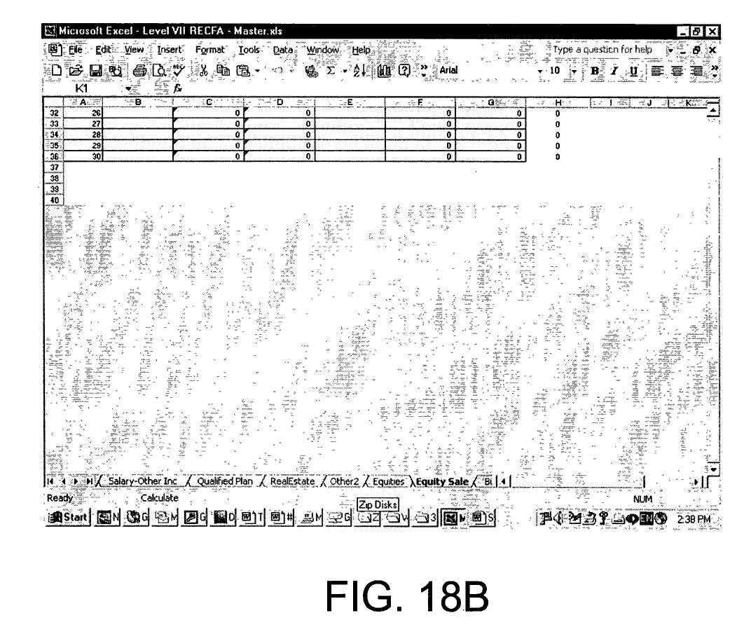

Equity Sale Sheet. An Equity Sale sheet 220 of the present invention is depicted in FIG. 18 and displayed by clicking a graphical icon tab 222. Equity Sale sheet 220 includes an equity sale table 224 (object name “stocksale_table”) for figuring sales of equities over the planned range of years. Equity sale table 224 is structured to have the following columns:

Year—Plan years 1-30 (not to be changed).

Stock Value—Amount of stock sold that year.

Basis—Participant's basis in the stock sold.

Capital Gains Tax—Calculation of capital gains tax on stock sold using capital gains tax rate entered at capital gains tax rate box 125 of tax Table sheet 120.

Total—After tax income on stock sold.

Today 's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

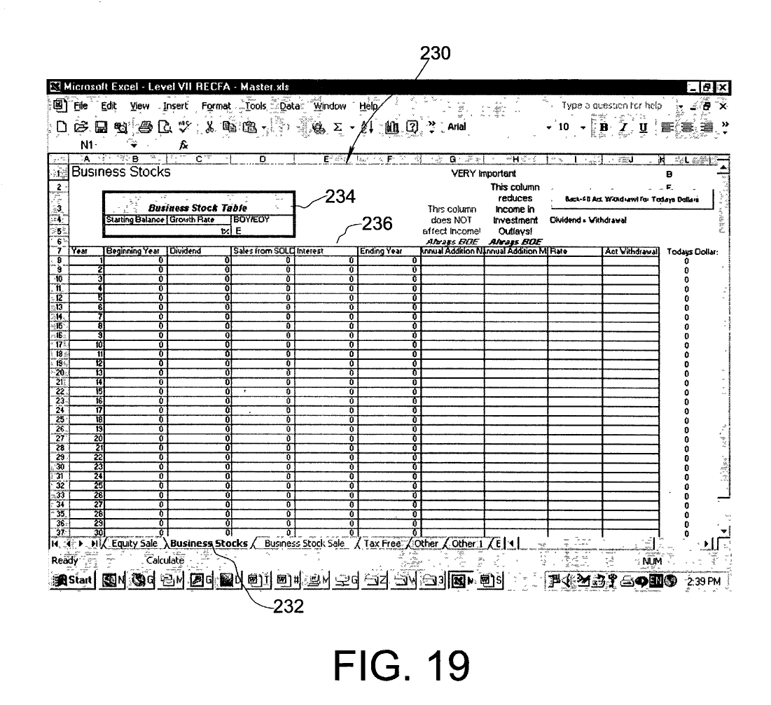

Business Stocks Sheet. FIG. 19 shows a Business Stocks sheet 230 of the present invention. Business Stocks sheet 230 is displayed by clicking a graphical icon tab 232 associated therewith, and includes a business stock parameter table 234 and a business stock table 236 (object name “cstocks_table”). Business stock parameter table 234 receives a starting balance, a growth rate that is the dividend rate on stock growth, and “B” or “E” to indicate whether benefits are payable at the beginning of the year or the end of the year. Business stock table 236 includes the following columns:

Year—Plan years 1-30 (not to be changed)

Beginning Year—Business stocks balance at beginning of year.

Dividend—Amount calculated from either the Rate or Act Withdrawal column described below. The need for two referenced columns is to utilize Excel's backsolve feature to assist in solving for a specific total income level. When the backsolve feature is used, the backsolve number is placed in the Act Withdraw column. All tables that affect total income have this feature.

Sales from Sold—Value of business stocks from the business stock sale table described hereinafter.

Interest—Annual dividend accrual using the growth rate entered into business stock parameter table 234.

Ending Year—Business stocks balance at end of year.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Rate—This column is used to schedule withdrawal of an amount equal to a fixed percentage of business stocks for any/all year(s) to income.

Act Withdrawal—Actual annual withdrawal amount from business stocks to income. Any entry in this column will override the Rate column entry for the year entered.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

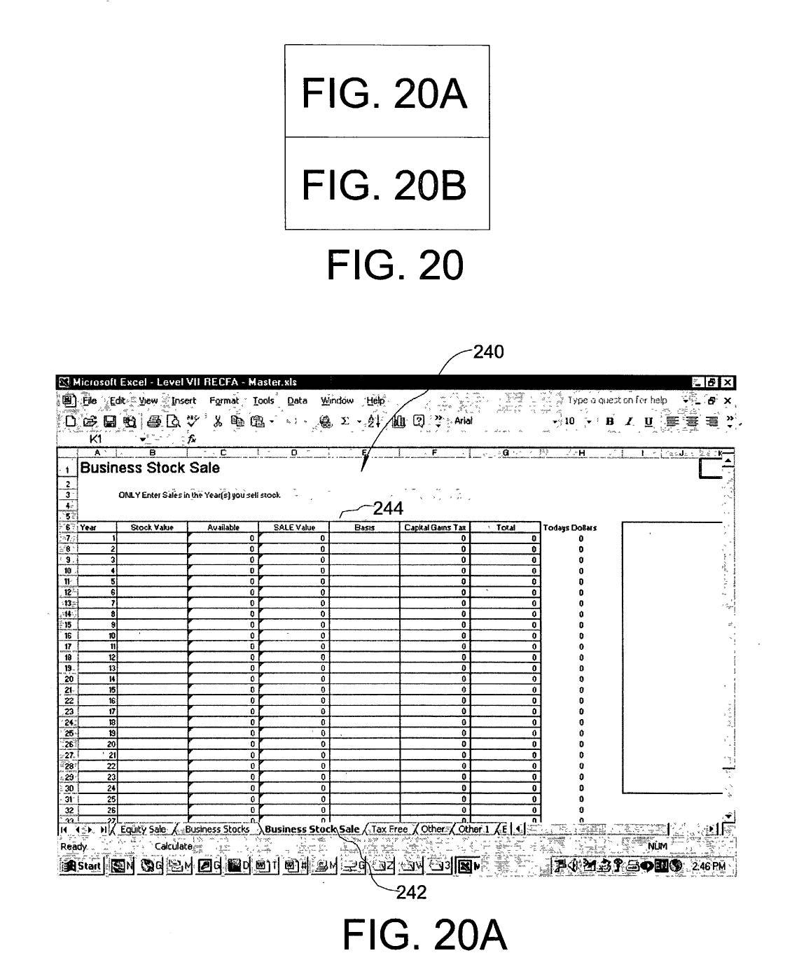

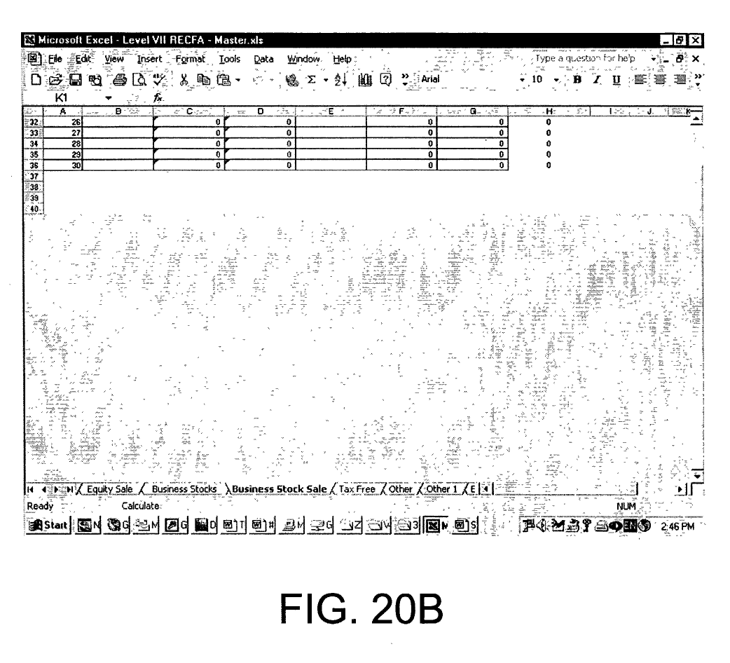

Business Stock Sale Sheet. A Business Stock Sale sheet 240 of the present invention is depicted in FIG. 20 and displayed by clicking a graphical icon tab 242. Business Stock Sale sheet 240 tab is primarily used to illustrate the sale of a private business interest, and includes a business stock sale table 224 (object name “cstocksale_table”) for figuring sales of business stocks over the planned range of years. Business stock sale table 224 is structured to have the following columns:

Year—Plan years 1-30 (not to be changed).

Stock Value—Amount of stock sold that year.

Basis—Participant's basis in the stock sold.

Capital Gains Tax—Calculation of capital gains tax on stock sold using capital gains tax rate entered at capital gains tax rate box 125 of tax Table sheet 120.

Total—After tax income on stock sold.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

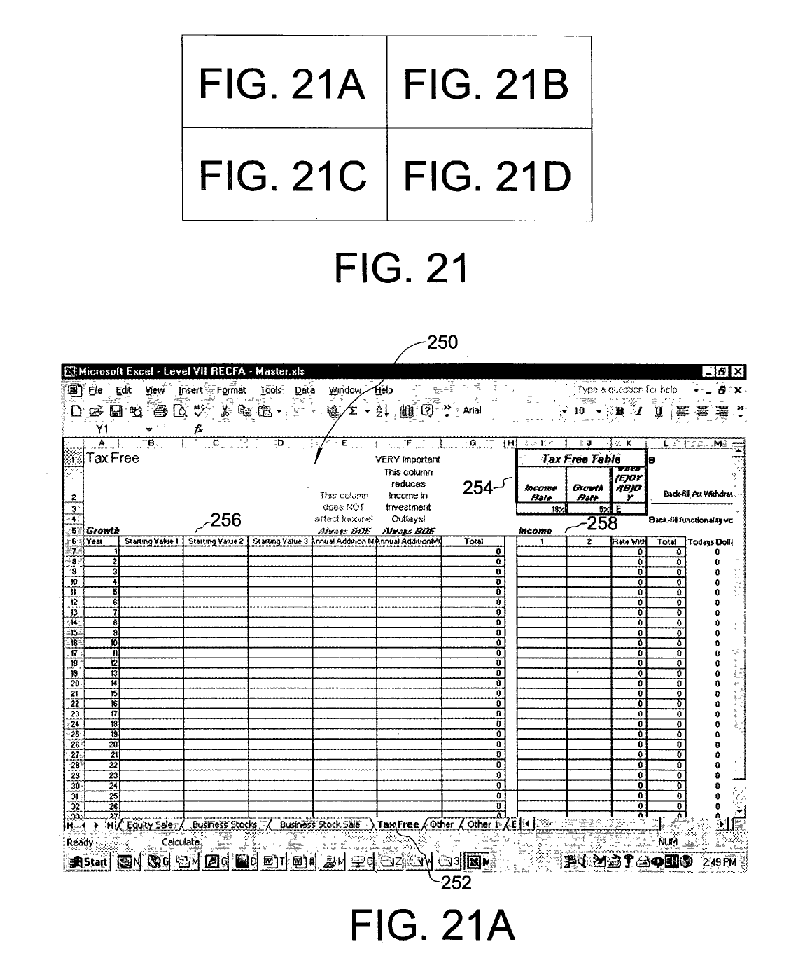

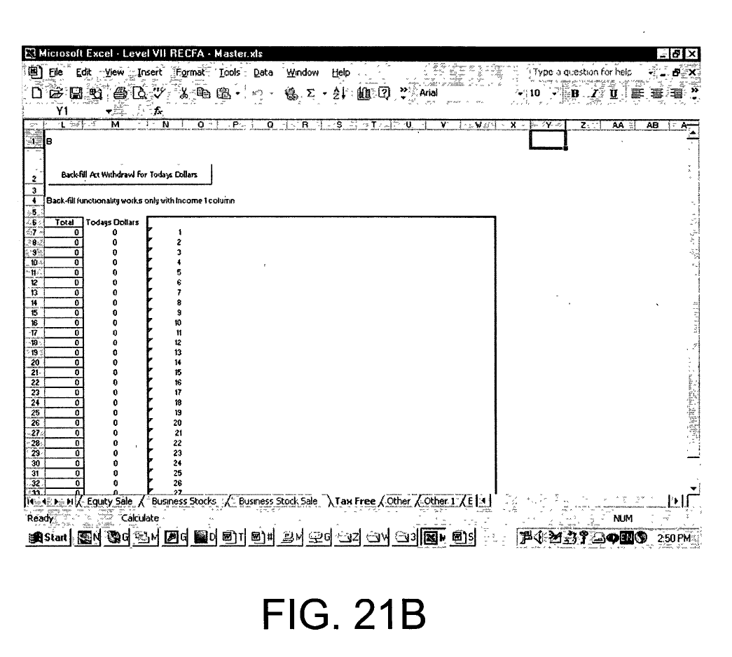

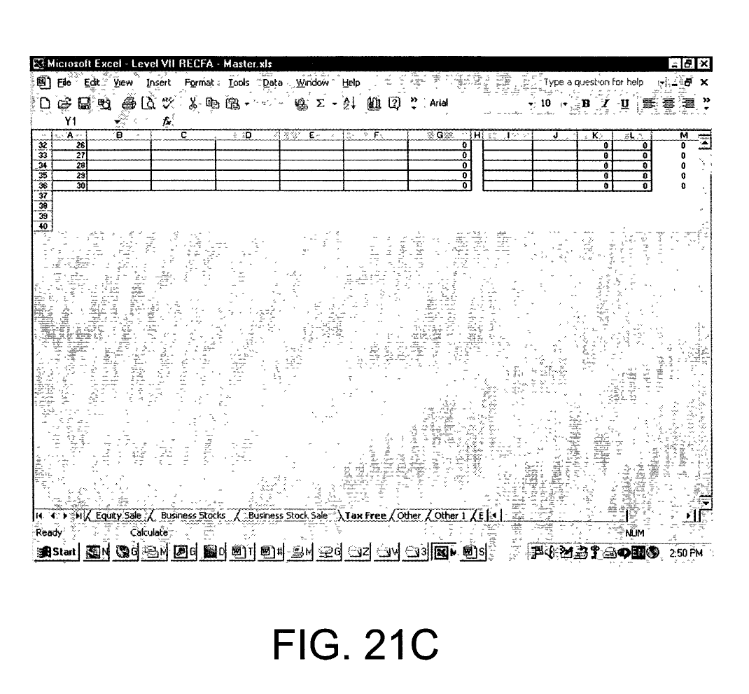

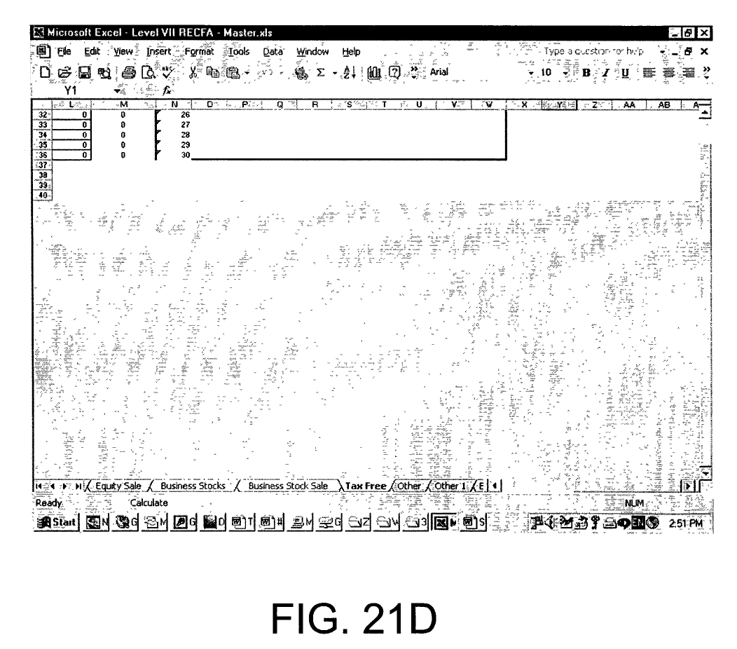

Tax Free Investments Sheet. FIG. 21 shows a Tax Free sheet 250 of the present invention that is used to project investments that grow tax free, such as tax free bonds/equities. Tax Free sheet 250 is displayed by clicking graphical icon tab 252, and includes a tax free parameter table 254, a tax free growth table 256, and a tax free income table 258 (object name of 256 and 258 combined is “TF_table”). Tax free growth table 256 allows projection of growth for up to three tax free investments, while tax free income table 258 illustrates income from up to three tax free investments with projection being possible for one of the three investments. Tax free parameter table 254 receives an income rate at which income is withdrawn from the third column of tax free income table 258, and a growth rate at which the tax free investments in tax free growth table 256 are projected to grow. Tax free growth table 256 includes the following columns:

Year—Plan years 1-30 (not to be changed).

Starting Value 1—Beginning value of first tax free investment.

Starting Value 2—Beginning value of second tax free investment.

Starting Value 3—Beginning value of third tax free investment.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Total—Ending value of the tax free investments after growth and withdrawals

Tax free income table 258 has information in four columns according to the following outline:

1—Manually entered tax free income value for a first tax free investment.

2—Manually entered tax free income value for a second tax free investment.

Rate With—Projected income on third tax free investment using income rate from tax free parameter table 254.

Total—Annual income value of the tax free investments.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

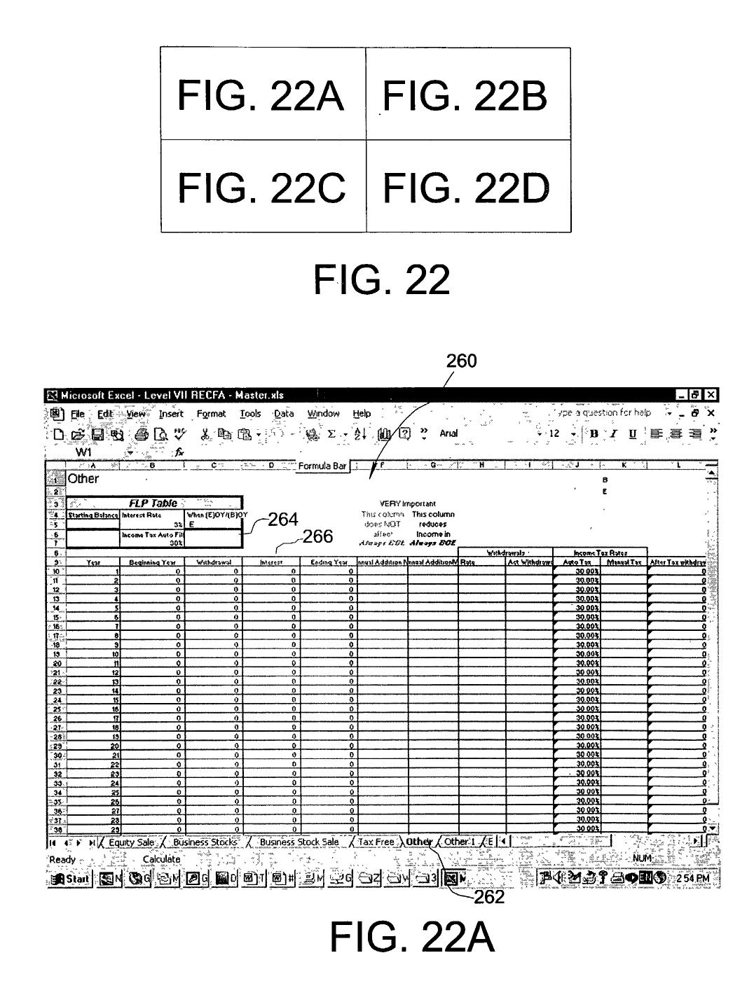

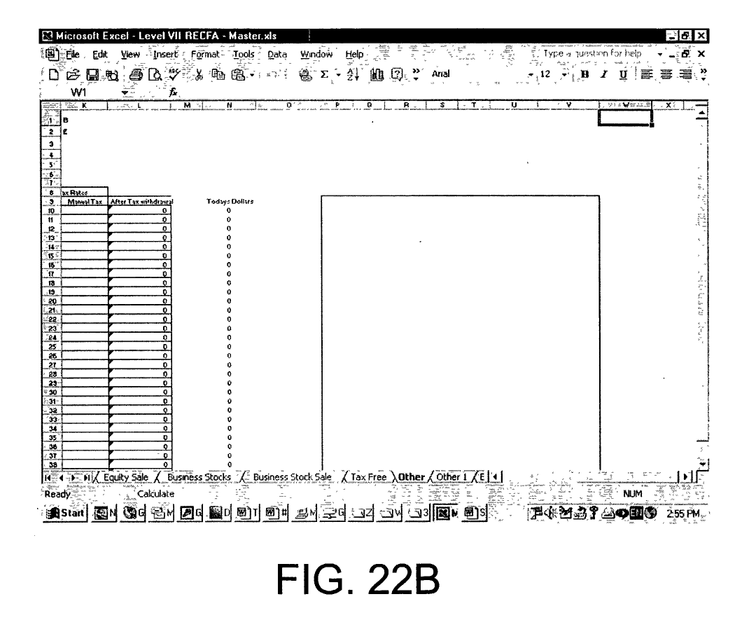

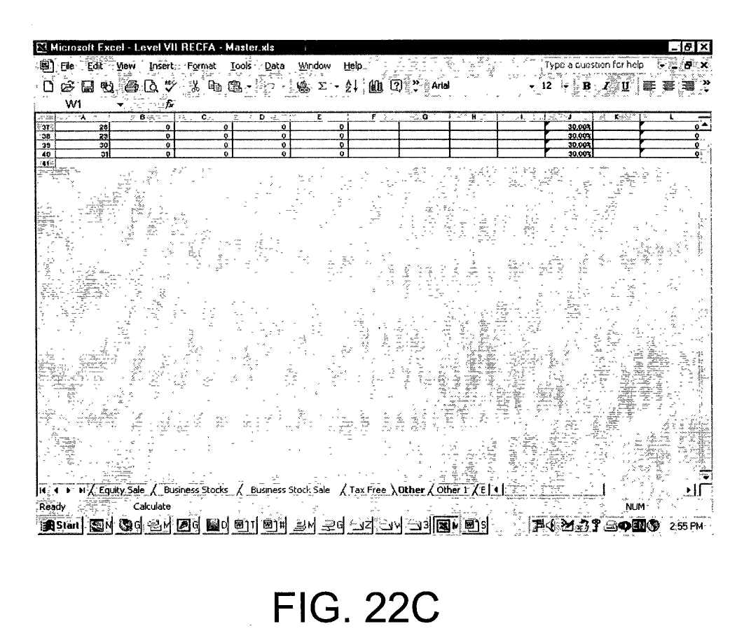

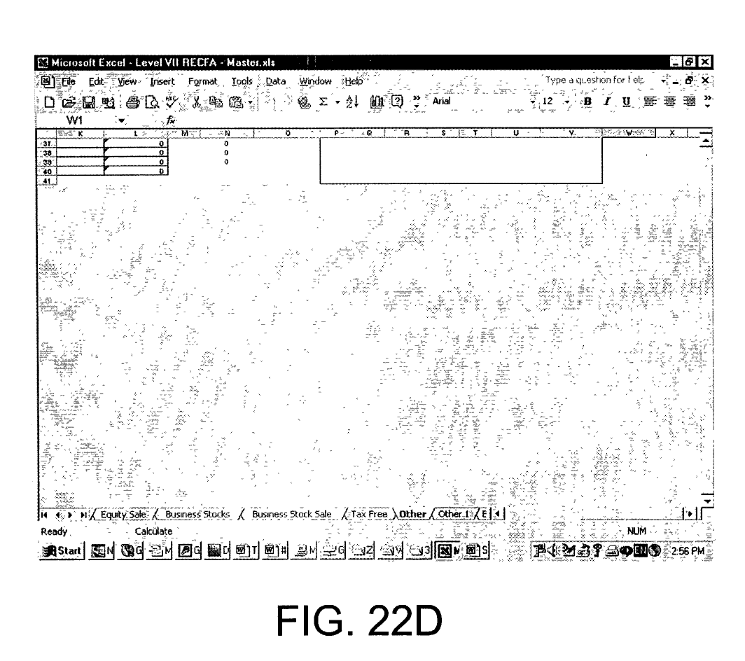

Family Limited Partnership (FLP) Sheet. An FLP sheet 260, shown in FIG. 22, can be used to project amounts attributed to a Family Limited Partnership (FLP). FLP sheet 260 includes a graphical icon tab 262, an FLP parameter table 264, and an FLP table 266 (object name “Deferred_tableta”). FLP parameter table 264 receives a starting balance, an interest rate at which the FLP accrues, “B” or “E” to indicate whether benefits are payable at the beginning of the year or the end of the year, and an income tax auto fill rate on the FLP (or an actual tax rate may be entered in the appropriate column of FLP table 266). FLP table 266 includes the following columns:

Year—Plan years 1-30 (not to be changed).

Beginning Year—FLP account balance at the beginning of the year.

Withdrawal—Amount calculated from either the Rate or Act Withdrawal column described below. The need for two referenced columns is to utilize Excel's backsolve feature to assist in solving for a specific total income level. When the backsolve feature is used, the backsolve number is placed in the Act Withdraw column. All tables that affect total income have this feature.

Interest—Annual interest accrual using the interest rate entered into FTP parameter table 264.

Ending Year—FLP account balance at the end of the year.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Rate—This column is used to schedule withdrawal of an amount equal to a fixed percentage of business stocks for any/all year(s) to income.

Act Withdrawal—Actual annual withdrawal amount from business stocks to income. Any entry in this column will override the Rate column entry for the year entered.

Auto Tax—Uses the auto tax rate entered in FLP parameter table 264 to calculate tax on the FLP.

Manual Tax—A manual tax rate entry that overrides the auto tax rate.

After Tax Withdrawal—Illustrates the after tax value of the FLP withdrawal.

Today 's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

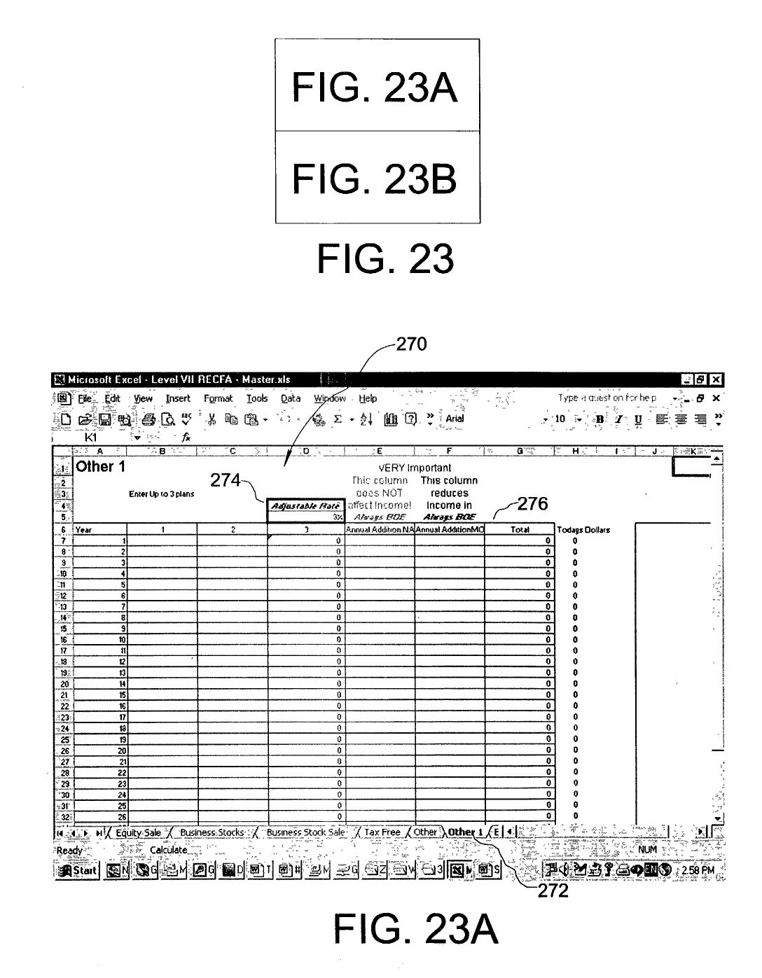

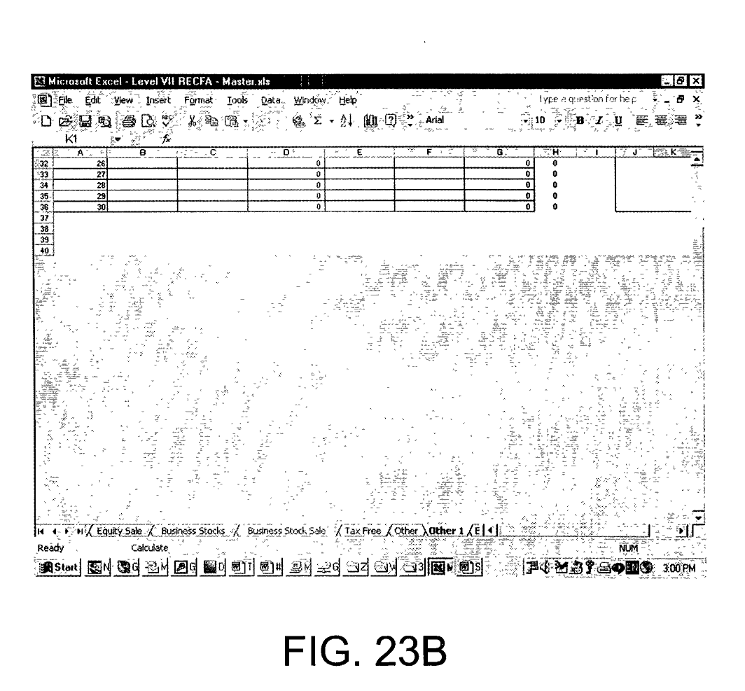

Other1 Sheet. FIG. 23 shows an Other1 sheet 270 used to project the performance of up to three other assets. Other1 sheet 270 is displayed by clicking graphical icon tab 272 and includes an adjustable rate box 274 for entering an interest rate for growth of a third asset, and an Other1 table 276 (object name “in_table”) that includes the following columns:

Year—Plan years 1-30 (not to be changed).

1—Manually entered asset value for a first asset.

2—Manually entered asset value for a second asset.

3—Projected income on a third asset using rate from adjustable rate box 274.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Total—Annual income value of the Other Assets.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

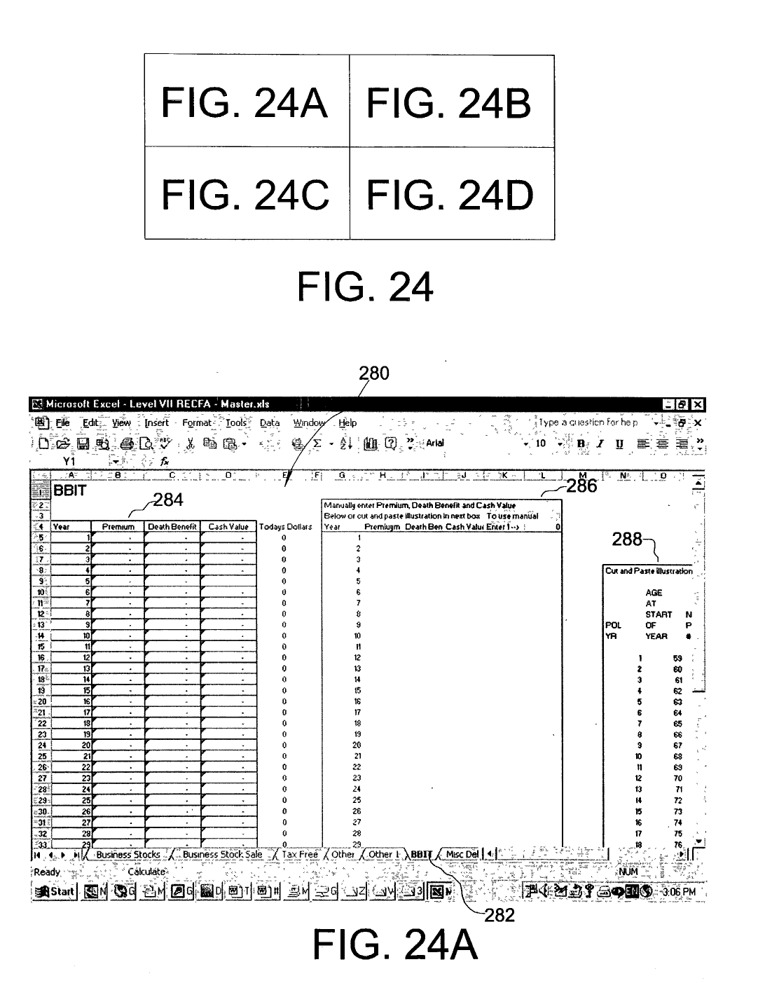

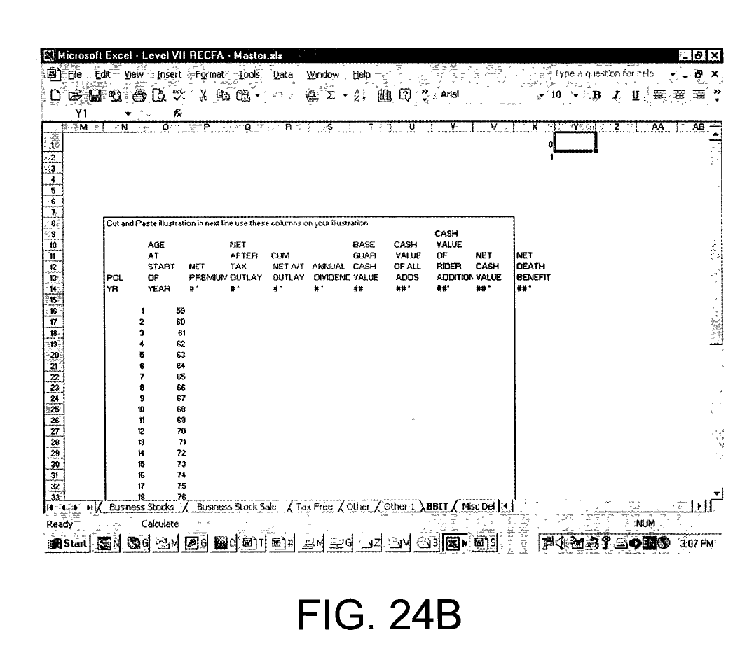

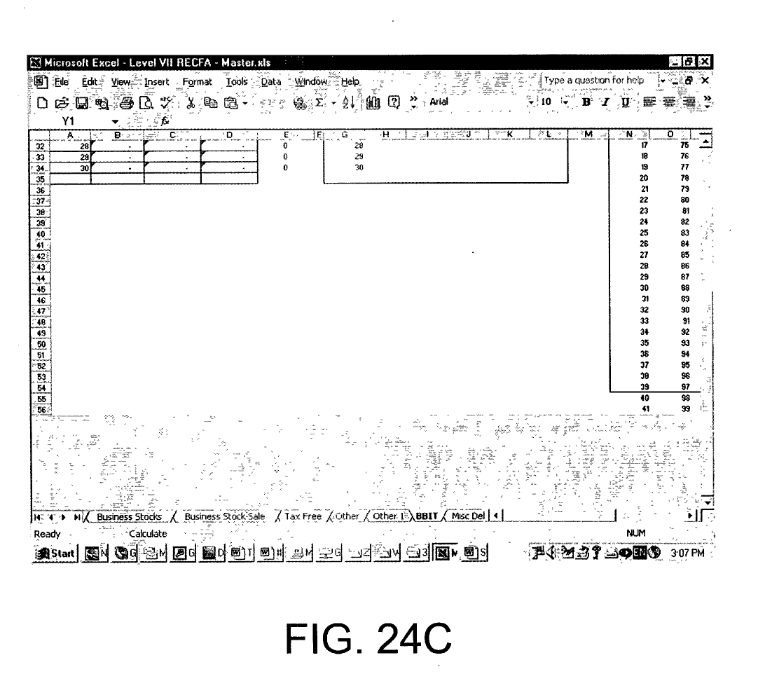

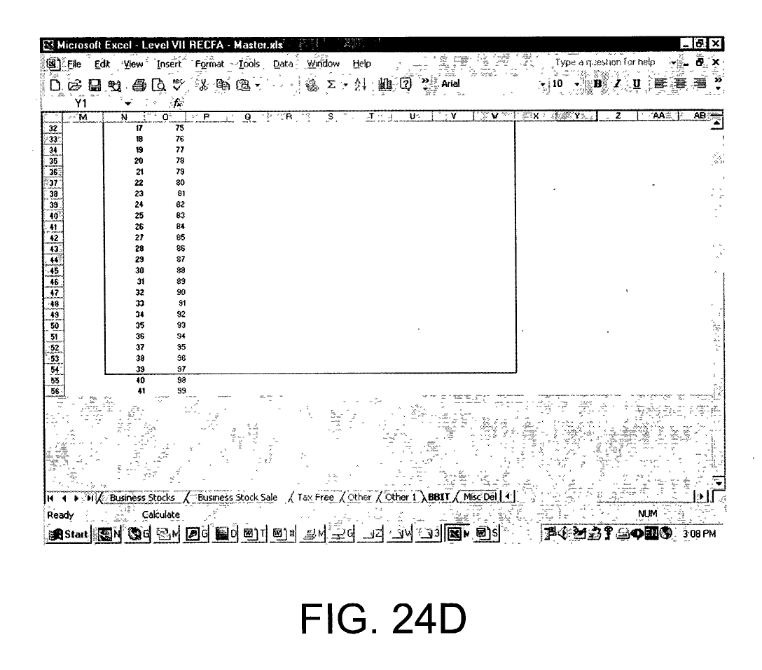

Bond Based Insurance Trust (BBIT) Sheet. A BBIT sheet 280 of the present invention can be seen in FIG. 24. BBIT sheet 280 includes a graphical icon tab 282, a BBIT table 284 (object name “Ilit_table”), a manual BBIT input block 286, and a cut and paste BBIT input block 288. The user may either manually enter the premium, death benefit, and cash value of a BBIT into manual BBIT input block 286 or electronically cut and paste this information into cut and paste BBIT input block 288. The information is automatically read into BBIT table 284, which includes columns for the plan year, premium, death benefit, cash value, and “Today's Dollars” adjusted cash value.

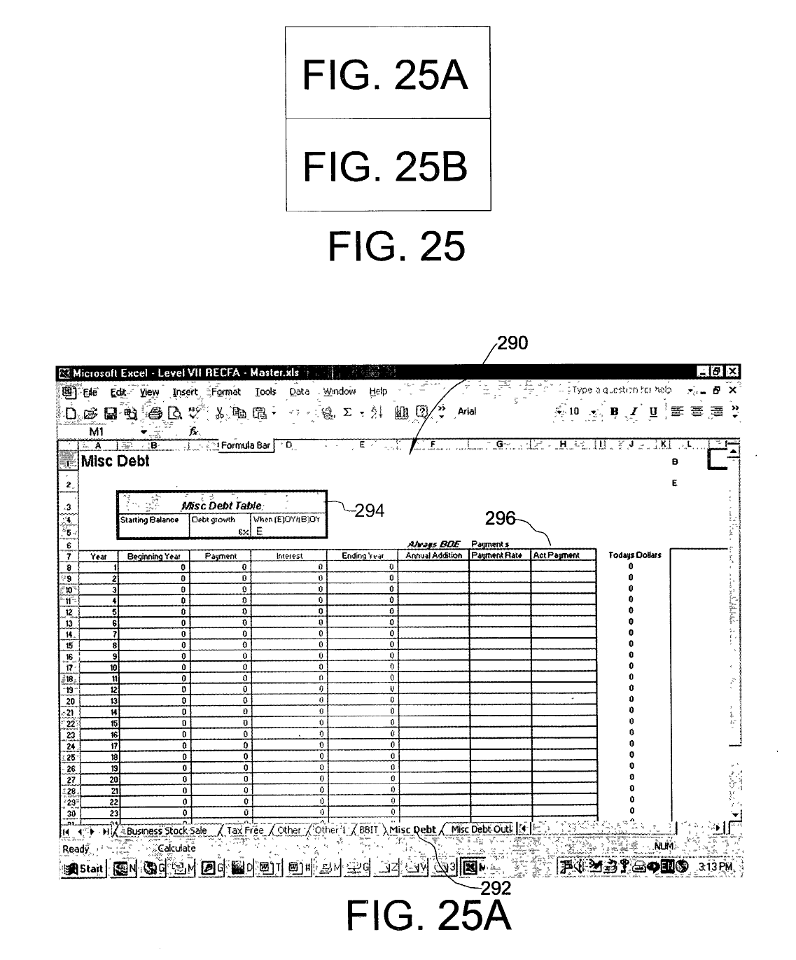

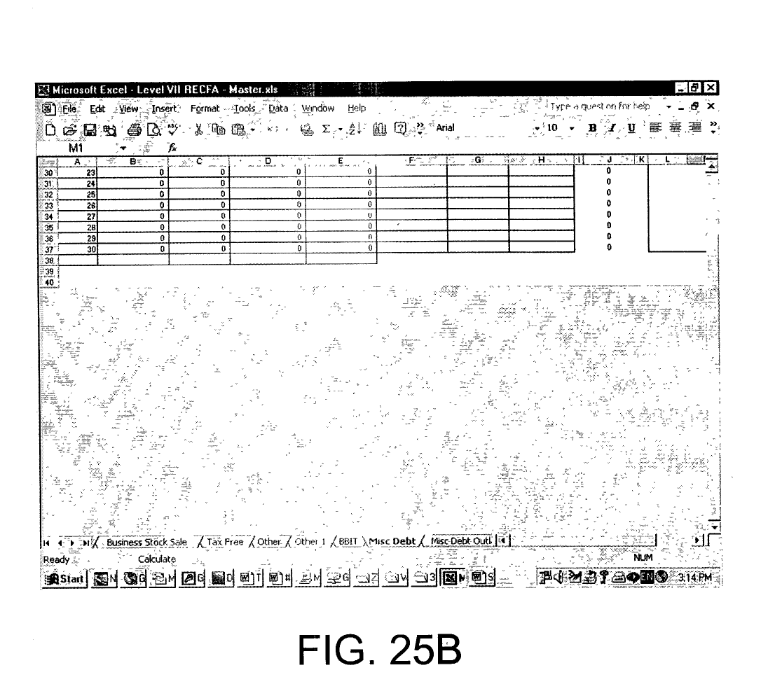

Miscellaneous Debt Sheet. FIG. 25 shows a Miscellaneous Debt sheet 290 of the present invention. Miscellaneous Debt sheet 290 is displayed by clicking a graphical icon tab 292, and includes a miscellaneous debt parameter table 294 and a miscellaneous debt table 296 (object name “debttable”). Miscellaneous debt parameter table 294 receives a starting balance, a debt growth rate, and “B” or “E” to indicate whether benefits are payable at the beginning of the year or the end of the year. Miscellaneous debt table 296 has information in its columns as follows:

Year—Plan years 1-30 (not to be changed)

Beginning Year—Misc Debt account balance at the beginning of the year.

Payment—Amount calculated from either the Payment Rate or Act Payment column described below. The need for two referenced columns is to utilize Excel's backsolve feature to assist in solving for a specific total income level. When the backsolve feature is used, the backsolve number is placed in the Act Payment column. All tables that affect total income have this feature.

Ending Year—Misc Debt account balance at the end of the year.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Payment Rate—This column is used to schedule payback of debt using a fixed percentage rate for any/all year(s) from income.

Act Payment—Actual annual payment to debt from income. Any entry in this column will override the Payment Rate column entry for the year entered.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

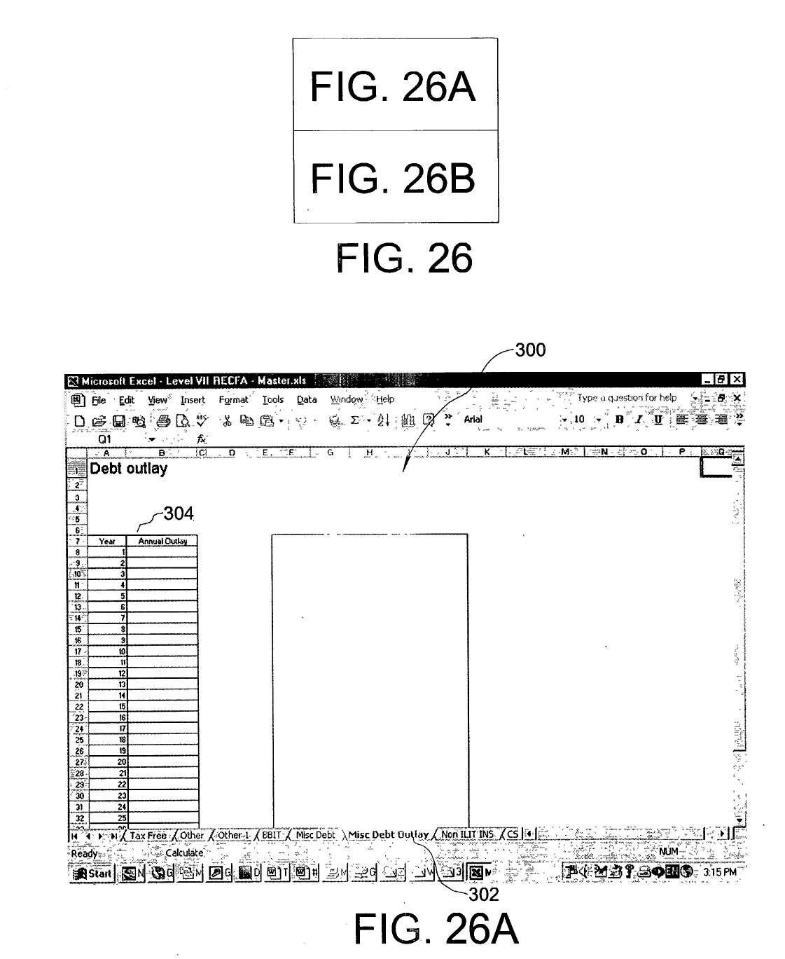

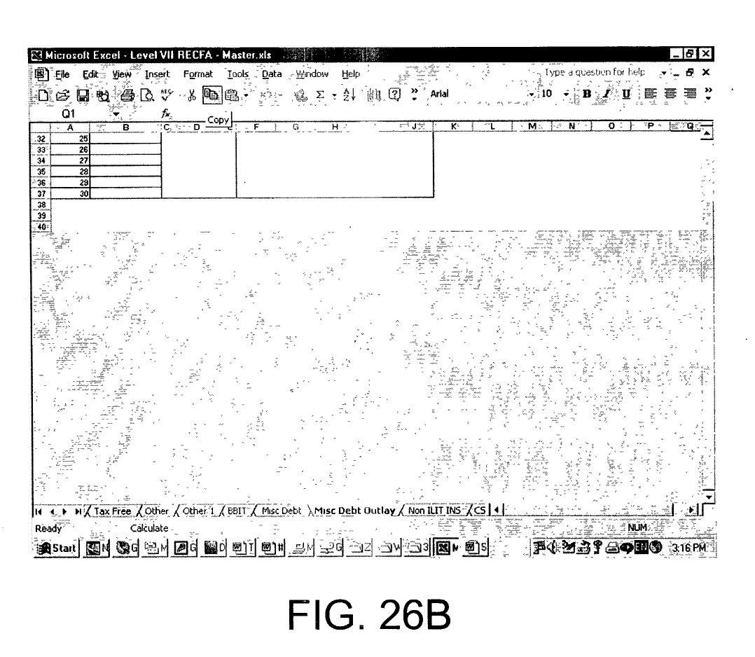

Miscellaneous Debt Outlay Sheet. Reference is now made to FIG. 26, which shows a Miscellaneous Debt Outlay sheet 300 of the present invention. Miscellaneous Debt Outlay sheet 300 is displayed by clicking a graphical icon tab 302 and includes a debt outlay table 304 (object name “Debtpayable”) allowing manual entry of a debt outlay amount for each plan year.

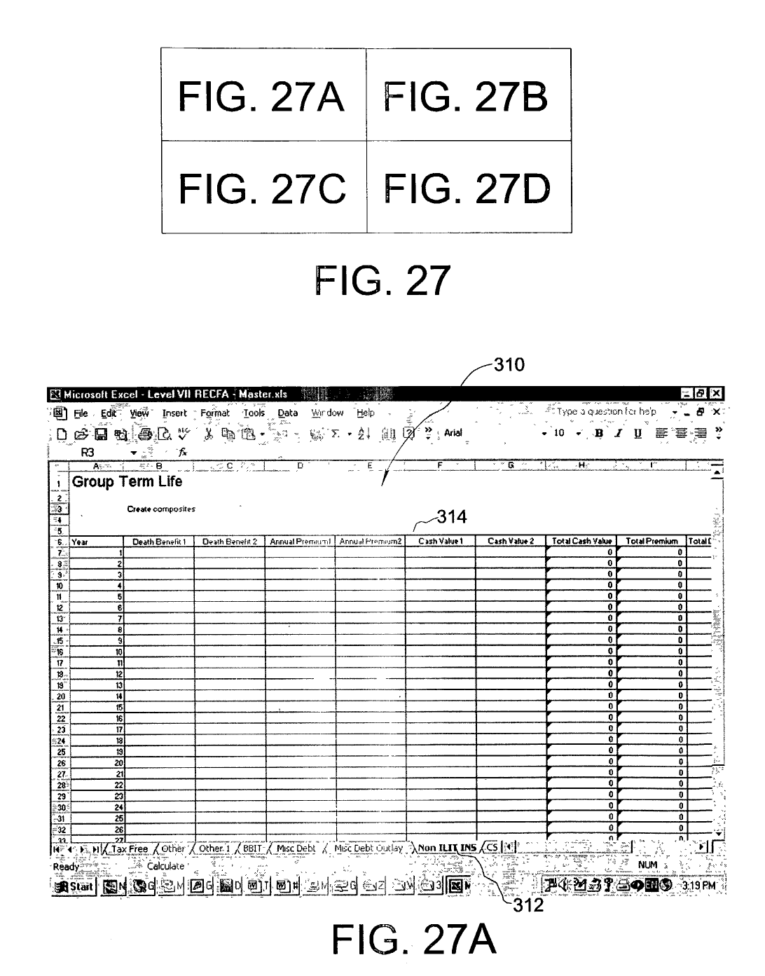

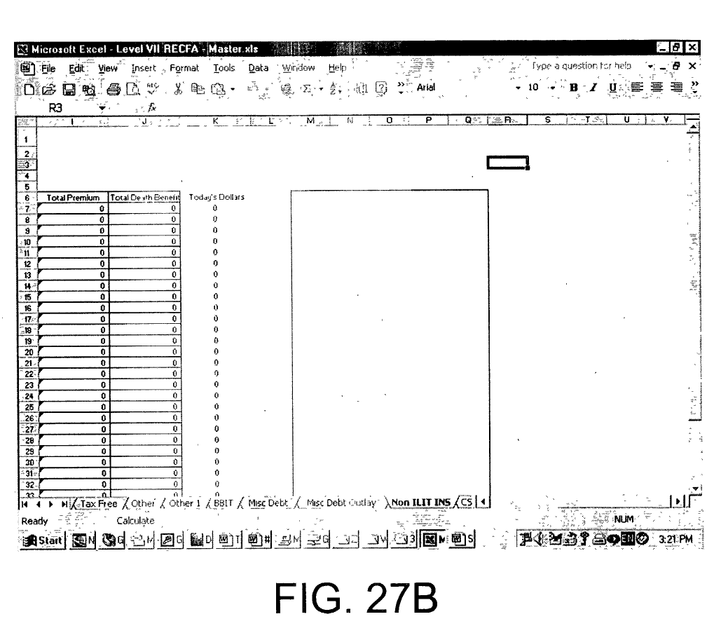

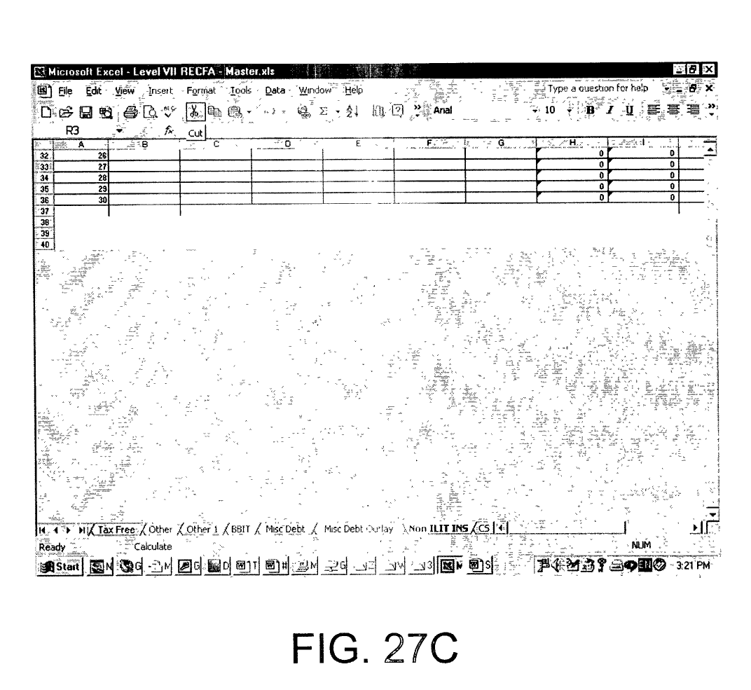

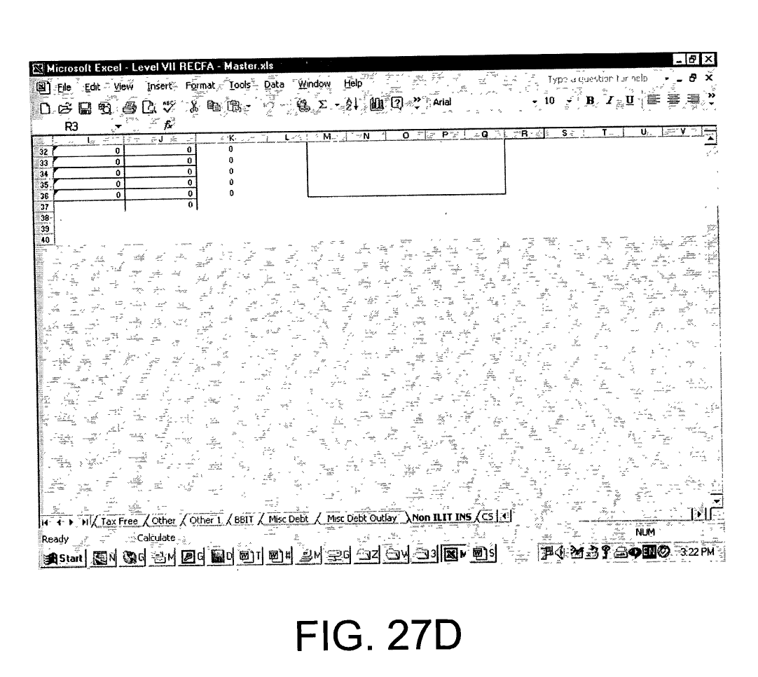

Group Term Life Insurance Sheet. A Group Term Life Insurance sheet 310, shown in FIG. 27, is used to enter annual premiums and death benefits that are attributable to a Life Insurance property that is not in an Irrevocable Life Insurance Trust (ILIT). Group Term Life Insurance sheet 310 includes a graphical tab icon 312 and a group term life insurance table 314 (object name “attable1”) having the following columns:

Year—Plan years 1-30 (not to be changed).

Death Benefit 1—The annual death benefit from a first non-ILIT insurance policy.

Death Benefit 2—The annual death benefit from a second non-ILIT insurance policy.

Premium 1—Annual premium on first non-ILIT insurance policy.

Premium 2—Annual premium on second non-ILIT insurance policy.

Total Premium—Summarizes Premium 1 and Premium 2 columns

Total Death Benefit—Summarizes Death Benefit 1 and Death Benefit 2 columns.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

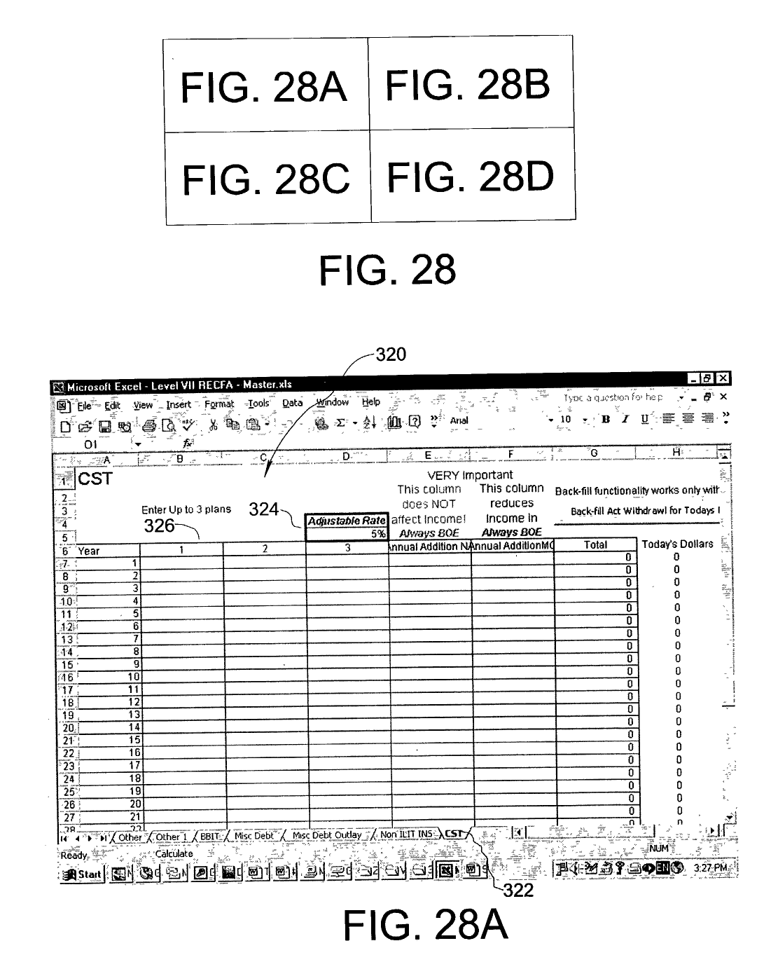

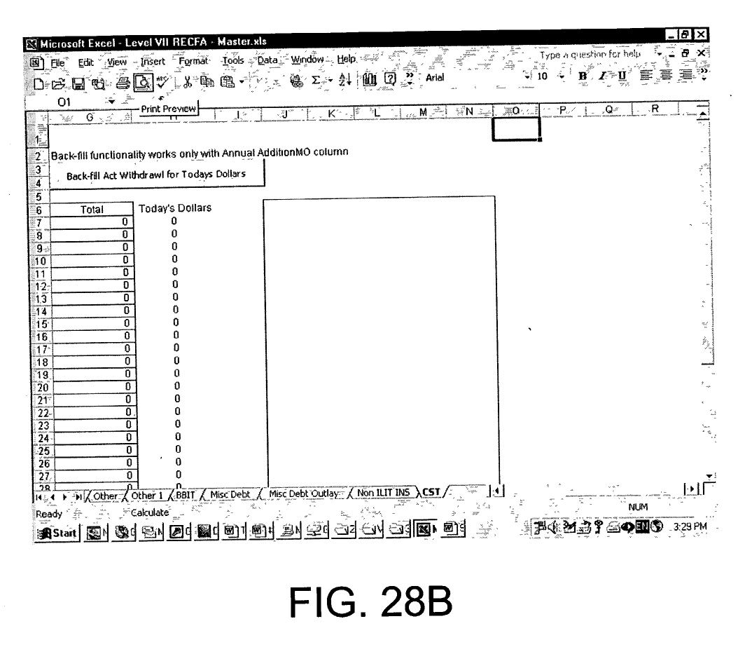

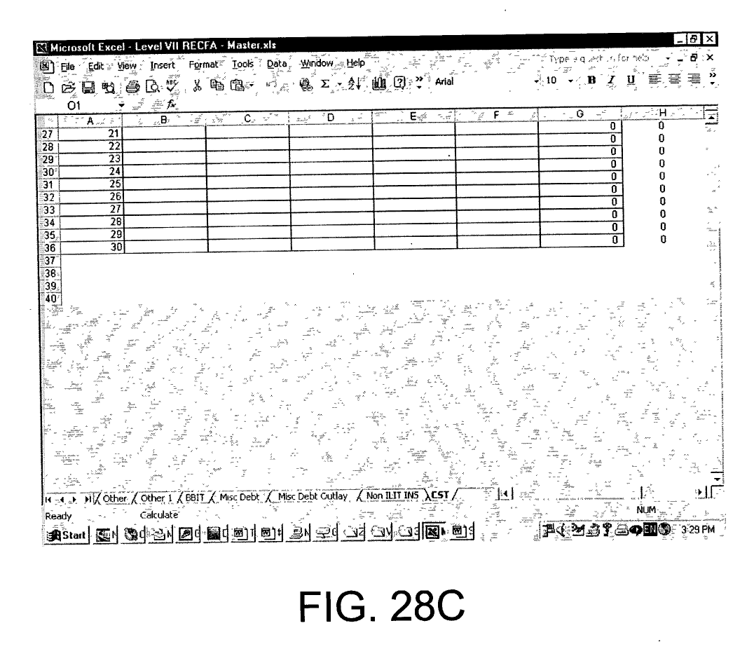

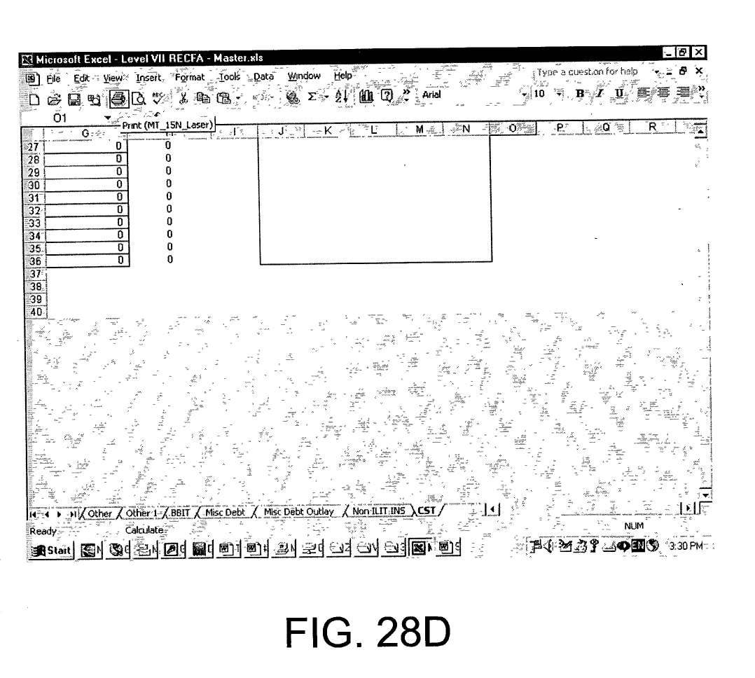

Credit Shelter Trust (CST) Sheet. FIG. 28 shows a Credit Shelter Trust (CST) sheet 320 used to project the performance of up to three CSTs. CST sheet 320 is displayed by clicking graphical icon tab 322 and includes an adjustable rate box 324 for entering an interest rate for growth of a third CST, and a CST table 326 (object name “attable2”) that includes the following columns:

Year—Plan years 1-30 (not to be changed).

1—Manually entered CST value for a first CST.

2—Manually entered CST value for a second CST.

3—Projected income on a third CST using rate from adjustable rate box 324.

Annual Addition NA—Addition for a given year may be entered. Additions entered in this column do NOT affect total income (i.e. inheritance income).

Annual Addition MO—Addition for a given year may be entered. Entries in this column adjust total income by affecting the Misc Outlays row of Spendable Income table 34 of Totals sheet 30 (i.e. excess income to savings account).

Total—Annual income value of the CSTs.

Today's Dollars—This amount equals the Consumer Price Index adjusted value, and is calculated in the CPI Adjustment table described below for each year from the Total Income row on the Spendable Income table 34 of Totals sheet 30. This column is used as a reference when using the Excel backsolve feature, and allows projection of future income in current year dollars.

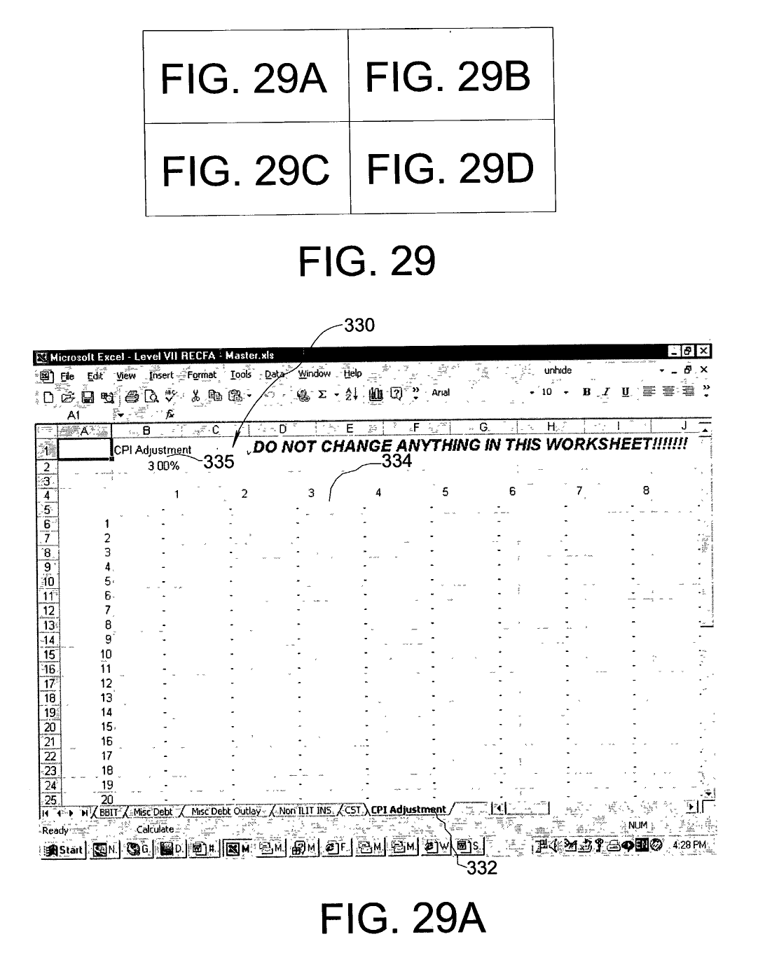

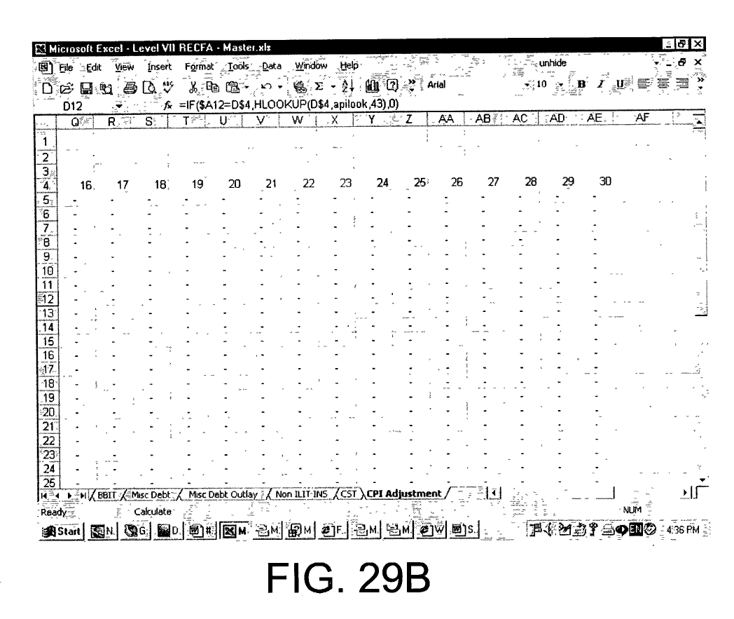

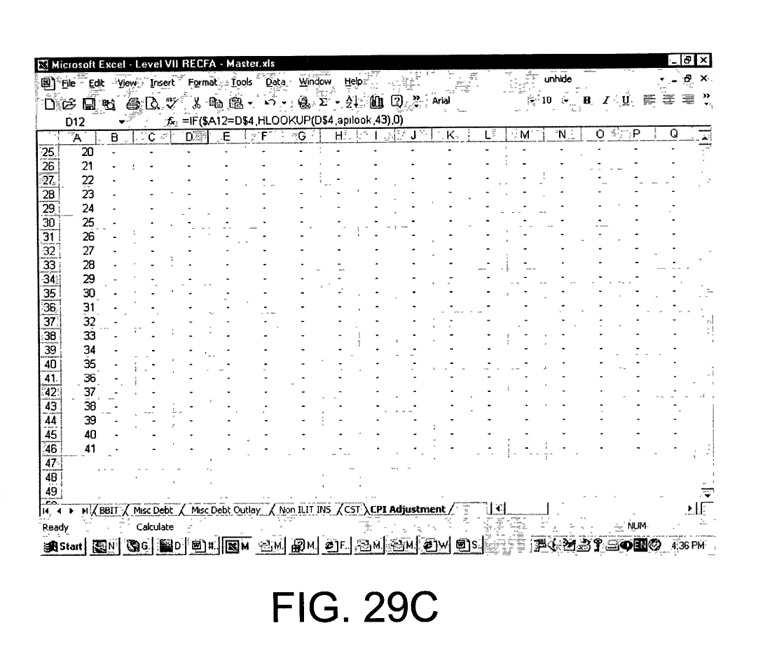

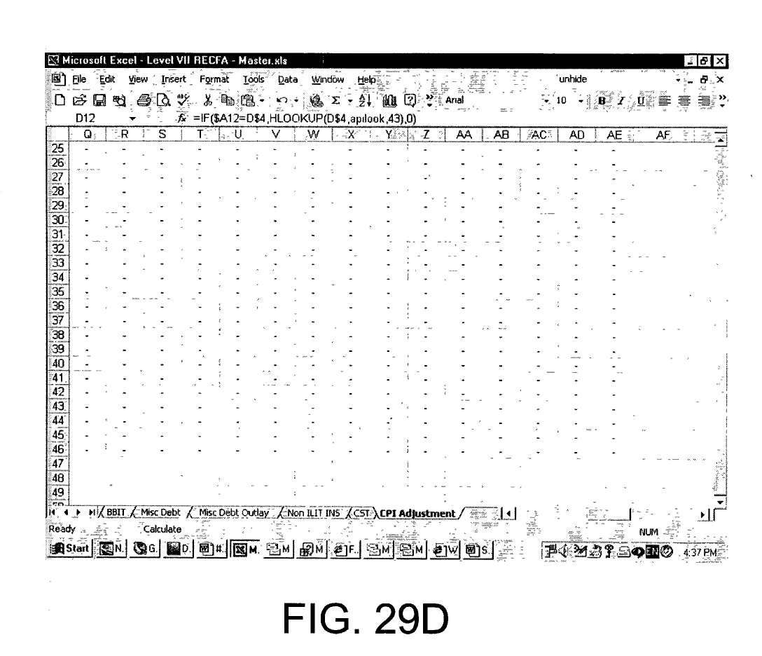

CPI Adjustment Sheet. A CPI Adjustment sheet provided in accordance with the present invention is shown in FIG. 29 and identified generally by the reference numeral 330. CPI Adjustment sheet 330 is displayed by clicking a graphical icon tab 332 and is used to calculate the net present value of future incomes (NPV). CPI Adjustment sheet 330 includes a CPI adjustment table 334 (object name “cpiadjtable”) that includes columns representing each individual plan year. In each column are rows of formulas that lookup income calculation from Totals sheet 30. The formula then looks up the year and places the appropriate income amount into the row that the year represents. CPI Adjustment sheet 330 sheet calculates the present value of the income received that year using a CPI rate (“cpirate”) entered at box 335, which present value is designated herein as “Today's Dollars”. It is preferred to “hide” CPI Adjustment sheet 330 in Excel to prevent unauthorized changes to the formulas and amounts. Table 3 below gives, by way of example, the formulas in the first three rows and two columns of CPI Adjustment sheet 330 (sheet rows 5 through 7 and sheet columns B and C.

TABLE 3

| | B | C |
|---|---|---|
| 5 | =NPV(cpirate,B7:B35)+B6 | =NPV(cpirate,C7:C35)+C6 |
| 6 | =IF($A6=B$4,HLOOKUP | =IF($A6=C$4,HLOOKUP(C$4, |
| | (B$4,apilook,43),0) | apilook,43),0) |
| 7 | =IF($A7=B$4,HLOOKUP | =IF($A7=C$4,HLOOKUP(C$4, |
| | (B$4,apilook,43),0) | apilook,43),0) |

What is claimed is:

1. A computer program product for providing asset information regarding a participant for purposes of retirement planning, said computer program product comprising:
a computer-readable medium having stored thereon a program code executable to provide a plurality of user interface sheets including:
(a) a summary sheet for calculating and indicating spendable income and total estate value for a plurality of different years in a planned range of years;
(b) a data input sheet for receiving participant plan information including a participant name, a start age, a retire age, a death age, a consumer price index rate, and a start year;
(c) a tax table sheet for receiving currently applicable tax rate information; and
(d) a plurality of categorized sheets for receiving and calculating information from which said spendable income and said total estate value are calculated;
wherein any one of said plurality of user interface sheets is selectable by a user by entering a single input command.

2. The computer program product according to claim 1, wherein each of said plurality of user interface sheets includes a graphical icon associated therewith, and said input command is entered by clicking a chosen graphical icon.

3. The computer program product according to claim 2, wherein said graphical icon is a tab icon for each of said plurality of user interface sheets.

4. The computer program product according to claim 1, wherein said computer program product provides asset information regarding a pair of participants.

5. The computer program product according to claim 1, wherein each of said plurality of categorized sheets includes a table having data for each year in said planned range of years.

6. The computer program product according to claim 5, wherein some of said data is calculated based on information entered to said categorized sheet by a user.

7. The computer program product according to claim 1, wherein said plurality of categorized sheets comprises at least two categorized sheets selected from the group consisting of a Social Security sheet, a savings sheet, a deferred income sheet, a salary and other income sheet, a qualified plan sheet, a real estate sheet, an other income and property sheet, an equities sheet, an equity sale sheet, a business stocks sheet, a business stock sale sheet, a tax free investments sheet, a bond based insurance trust sheet, a miscellaneous debt sheet, a miscellaneous debt outlay sheet, a non-irrevocable life insurance trust sheet, and a credit shelter trust sheet.

8. The computer program product according to claim 7, wherein said plurality of categorized sheets comprises a Social Security sheet, a savings sheet, a deferred income sheet, a salary and other income sheet, a qualified plan sheet, a real estate sheet, an other income and property sheet, an equities sheet, an equity sale sheet, a business stocks sheet, a business stock sale sheet, a tax free investments sheet, a bond based insurance trust sheet, a miscellaneous debt sheet, a miscellaneous debt outlay sheet, a non-irrevocable life insurance trust sheet, and a credit shelter trust sheet.

9. The computer program product according to claim 1, wherein said plurality of user interface sheets includes more than one said summary sheet.

10. The computer program product according to claim 1, wherein said plurality of user interface sheets includes an assumption sheet for indicating assumed parameters and inputted information.

11. The computer program product according to claim 1, further comprising a consumer price index adjustment sheet for use in converting future projected values into present values.

12. A computer system operable to provide asset information regarding a participant for purposes of retirement planning, said computer system comprising:
a computer;
a display connected to said computer for displaying information;
an input device connected to said computer for entering input commands to said computer; and
computer software executable by said computer to provide a plurality of user interface sheets displayable on said display, said plurality of user interface sheets including:
(a) a summary sheet for calculating and indicating spendable income and total estate value for a plurality of different years in a planned range of years;
(b) a data input sheet for receiving participant plan information including a participant name, a start age, a retire age, a death age, a consumer price index rate, and a start year;
(c) a tax table sheet for receiving currently applicable tax rate information; and
(d) a plurality of categorized sheets for receiving and calculating information from which said spendable income and said total estate value are calculated;
wherein any one of said plurality of user interface sheets is selectable by a user by entering a single input command.

13. The computer system according to claim 12, wherein said display and said input device are connected to said computer by a network.

14. The computer system according to claim 12, wherein each of said plurality of user interface sheets includes a graphical icon associated therewith, and said input command is entered by clicking a chosen graphical icon.

15. The computer system according to claim 14, wherein said graphical icon is a tab icon for each of said plurality of user interface sheets.

16. The computer system according to claim 12, wherein said computer system provides asset information regarding a pair of participants.

17. The computer system according to claim 12, wherein each of said plurality of categorized sheets includes a table having data for each year in said planned range of years.

18. The computer system according to claim 17, wherein some of said data is calculated based on information entered to said categorized sheet by a user.

19. The computer system according to claim 12, wherein said plurality of categorized sheets comprises at least two categorized sheets selected from the group consisting of a Social Security sheet, a savings sheet, a deferred income sheet, a salary and other income sheet, a qualified plan sheet, a real estate sheet, an other income and property sheet, an equities sheet, an equity sale sheet, a business stocks sheet, a business stock sale sheet, a tax free investments sheet, a bond based insurance trust sheet, a miscellaneous debt sheet, a miscellaneous debt outlay sheet, a non-irrevocable life insurance trust sheet, and a credit shelter trust sheet.

20. The computer system according to claim 19, wherein said plurality of categorized sheets comprises a Social Security sheet, a savings sheet, a deferred income sheet, a salary and other income sheet, a qualified plan sheet, a real estate sheet, an other income and property sheet, an equities sheet, an equity sale sheet, a business stocks sheet, a business stock sale sheet, a tax free investments sheet, a bond based insurance trust sheet, a miscellaneous debt sheet, a miscellaneous debt outlay sheet, a non-irrevocable life insurance trust sheet, and a credit shelter trust sheet.

21. The computer system according to claim 12, wherein said plurality of user interface sheets includes more than one said summary sheet.

22. The computer system according to claim 12, wherein said plurality of user interface sheets includes an assumption sheet for indicating assumed parameters and inputted information.

23. The computer program product according to claim 12, further comprising a consumer price index adjustment sheet for use in converting future projected values into present values.

24. A computer-implemented method for providing asset information regarding a participant for purposes of retirement planning, said method comprising the steps of:
(A) executing computer software to provide a plurality of user interface sheets each displayable by clicking an associated graphical icon corresponding to said user interface sheet, said plurality of user interface sheets including:
(1) a summary sheet for calculating and indicating spendable income and total estate value for a plurality of different years in a planned range of years;
(2) a data input sheet for receiving participant plan information including a participant name, a start age, a retire age, a death age, a consumer price index rate, and a start year;
(3) a tax table sheet for receiving currently applicable tax rate information; and
(4) a plurality of categorized sheets for receiving and calculating information from which said spendable income and said total estate value are calculated;
(B) displaying said data input sheet and entering information for receipt by said data input sheet;
(C) displaying a selected one of said plurality of categorized sheets applicable to said participant and entering information for receipt by said selected categorized sheet;
(D) repeating said step (C) for any others of said plurality of categorized sheets applicable to said participant; and
(E) displaying said summary sheet.
